(19) United States
(12) Patent Application Publication
(10) Pub. No.: US 2026/0230034 A1
(43) Pub. Date: Aug. 6, 2026

(54) FRAMES FOR SOLAR PANELS

(71) Applicant: NEXTPOWER LLC, FREMONT, CA (US)

(72) Inventors: Eric HAFTER, Sacramento, CA (US); John C. PATTON, Rocklin, CA (US); Tyler HUDSON, Cocolalla, ID (US)

(21) Appl. No.: 19/168,763

(22) PCT Filed: Mar. 22, 2024
(86) PCT No.: PCT/US2024/021118

§ 371 Date: Sep. 24, 2025

Related U.S. Application Data
(60) Provisional application No. 63/492,232, filed on Mar. 25, 2023.

(51) Int. Cl. H02S 30/10

(52) U.S. Cl. CPC H02S 30/10

(57) ABSTRACT

Embodiments of the application may include frames and methods for making frames to at least partially enclose or support a solar panel including an elongated piece of framework material which has been folded to form a folded, framework having at least some portions of overlapped framework and a securement between some of the overlapped framework. Securements may include but are not limited to teeth, dimples, tab locks, adhesives, grip surfaces, or the like and may provide strength and even anti-twisting properties to a frame.

This application is a PCT international patent application claiming priority to and the benefit of U.S. App. No. 63/492,232, filed Mar. 25, 2023, hereby incorporated by reference herein in its entirety.

### TECHNICAL FIELD

The present disclosure relates to various embodiments for frame structures for panels such as solar panels.

### BACKGROUND

Photovoltaic solar panels for residential and commercial use are relatively large and heavy. For example, a typical rectangular solar panel may weigh about 20-30 kg, have a width of about 1 meter, a length of about 1.6 to 2.5 meters, and a thickness of about 3 to 5 cm. A photovoltaic solar panel may typically be a multilayer laminated structure (sometimes referred to as a PV laminate) and may include photovoltaic cells encapsulated between a top glass and a protective back-sheet. A solar panel can further include appropriate wiring and junctions so that solar-generated electricity (typically DC) may be transmitted to a desired load, grid, or energy storage unit. While having some physical toughness, significant additional strength to the panel may be provided by including it in a frame. A frame may allow for easy attaching of a photovoltaic solar panel to a rack. A framed PV laminate is sometimes referred to as a PV module.

Over the years, the cost of solar panels has decreased perhaps due to a decrease in the material and manufacturing costs and even an increased efficiency of the solar cells. However, in order to further expand the use of renewable solar energy, there is a continuing desire to further reduce costs and simplify the manufacture of frames.

### DISCLOSURE OF INVENTION

The present application includes a variety of aspects, which may be selected in different combinations based upon the particular application or needs to be addressed. In various embodiments, the present application may include a frame for at least partially enclosing or supporting a panel. The frame may include at least a first frame section including a bottom flange provided at a base of the frame section. A frame sidewall may be provided at an outer portion of the frame section, the frame sidewall characterized by a height extending from the bottom flange. A panel containment structure may be provided at an upper portion of the frame sidewall, the panel containment structure comprising a lower shelf. A panel containment structure may also be referred to as a pocket or glass pocket. A support wall may be provided at an inner portion of the frame section, the support wall extending (i) between the bottom flange and the frame sidewall, (ii) between the bottom flange and the lower shelf, or (iii) both (i) and (ii). The bottom flange, frame sidewall, lower shelf, support wall, and pocket may be formed from a single piece of framework material.

Embodiments of frames, frame sections, and frame precursor structures herein may provide one or more of the following advantages: improved frame strength, improved mounting structures; improved options for high-strength modules; improved bending resistance; improved twisting resistance, improved durability of framed panel structures; reduced material costs; reduced manufacturing costs; reduced manufacturing tack time; higher manufacturing yield; reduced installation costs; simplified installation; reduced installation time; higher installation yield; or some other advantage.

Naturally, further objects, goals and embodiments of the present application are disclosed throughout other areas of the specification, claims, and drawings.

### BRIEF DESCRIPTION OF DRAWINGS

FIG. 1A is a plan view of a non-limiting example of a framed panel structure according to some embodiments.

FIG. 1B is a cross-sectional view of a non-limiting example of a framed panel structure along cutline B-B of FIG. LA according to some embodiments.

FIG. 1C is the cross-sectional view from FIG. 1B showing a non-limiting example of just the frame according to some embodiments.

FIG. 2A is a plan view of a non-limiting example of a frame precursor structure and a panel prior to assembling a framed panel structure according to some embodiments.

FIG. 2B is a cross-sectional view of a non-limiting example of a frame precursor structure and a panel along cutline B-B of FIG. 2A according to some embodiments.

FIG. 2C is the cross-sectional view from FIG. 2B showing a non-limiting example of just the frame precursor structure according to some embodiments.

FIG. 2D is a side view with slight elevation of a non-limiting example of a frame precursor structure according to some embodiments.

FIG. 2E is a plan view of a non-limiting example of a frame precursor structure and a panel at an intermediate stage of assembly according to some embodiments.

FIG. 3 is a plan view showing a non-limiting example of assembling a frame using four frame precursor structures according to some embodiments.

FIG. 4A is a perspective view of a non-limiting example of a frame that includes a cross bar according to some embodiments.

FIG. 4B is a zoomed in view of area B from FIG. 4A according to some embodiments.

FIG. 5 is a schematic diagram of a non-limiting example of a manufacturing process line for making frame precursor structures according to some embodiments.

FIG. 6A is a perspective view of a cutaway portion of a non-limiting example of a frame section including a support wall according to some embodiments.

FIG. 6B is a cross-sectional view of the frame section from FIG. 6A according to some embodiments.

FIG. 6C is an enlarged view of the pocket section of FIG. 6B.

FIG. 6D is a plan view of a non-limiting example of a portion of framework material according to some embodiments.

FIG. 6E is a cross-sectional view of a non-limiting example of a framed panel structure according to some embodiments.

FIG. 7A is a perspective view of a portion of a non-limiting example of a semi-folded frame with bent, sharp teeth.

FIG. 7B is a side view of the semi-bent frame shown in FIG. 7A.

FIG. 7C is a side view of a further bent frame shown in FIG. 7B.

FIG. 7D is a side view of the fully formed frame shown in FIGS. 7A and 7B.

FIG. 8A is a perspective view of a portion of a non-limiting example of a frame with a dimpled locking mechanism.

FIG. 8B is a side view of a cutaway of the frame shown in FIG. 8A.

FIG. 8C is a side view of a cutaway of the frame shown in FIGS. 8A and 8B that also shows a representative tool that could form said dimples.

FIG. 8D is a side view of a cutaway of a similar frame as shown in FIGS. 8A and 8B but with a non-limiting example of a hole that the dimpled feature may press into.

FIG. 9A is a perspective view of a portion of a non-limiting example of a frame with a bent-teeth locking mechanism.

FIG. 9B is a side view of the frame shown in FIG. 9A.

FIG. 10A is a perspective view of a portion of a non-limiting example of a frame with another bent-teeth locking mechanism.

FIG. 10B is a side view of the frame shown in FIG. 10A.

FIG. 10C is a perspective, cutaway view of the frame shown in FIGS. 10A and 10B.

FIG. 10D is a perspective, opposing cutaway view of the frame shown in FIG. 10C.

FIG. 11 is a side view of a non-limiting example of a frame fastened with an adhesive or similar substance.

FIG. 12A is a perspective view of a non-limiting example of a bent tab locking mechanism.

FIG. 12B is a side view of the frame shown in FIG. 12A.

FIG. 12C is a perspective, cutaway view of the example frame shown in FIGS. 12A and 12B.

FIG. 13 is a side view of a non-limiting example of a frame with a coined locking mechanism.

FIG. 14A is a perspective view of a non-limiting example of a set of rollers that could be used to form any of the examples shown in FIGS. 7A-13.

FIG. 14B is a side view of the rollers shown in FIG. 14A.

FIG. 14B is another side view of the rollers shown in FIG. 14A with a non-limiting example of raised features that may form the locking features in the frame.

FIG. 15A is a top perspective view of some non-limiting examples of a frame section having locking features according to some embodiments.

FIG. 15B is an enlarged perspective view of FIG. 15A.

FIG. 15C is a bottom perspective view of some non-limiting examples of a frame section having locking features according to some embodiments.

FIG. 15D is an enlarged perspective view of FIG. 15C.

FIG. 15E is a top plan view of some non-limiting examples of a frame section having locking features according to some embodiments.

FIG. 15F is an enlarged top plan view of FIG. 15E which shows the sectioned top lip layer coupon cut out area.

FIGS. 15G and 15I show perspective views of some non-limiting examples of top lip layer coupons having locking features according to some embodiments.

FIG. 15H shows a top plan view of some non-limiting examples of top lip layer coupon having locking features according to some embodiments.

FIGS. 15J and 15K show perspective views of some non-limiting examples of top lip layer coupons having locking features according to some embodiments.

FIGS. 15L and 15M show end plan views of some non-limiting examples of coupons having locking features according to some embodiments.

FIG. 15N shows a perspective view of some non-limiting examples of top lip layer coupons having locking features according to some embodiments.

FIG. 150 shows an end plan view of some non-limiting examples of top lip layer coupons having locking features according to some embodiments.

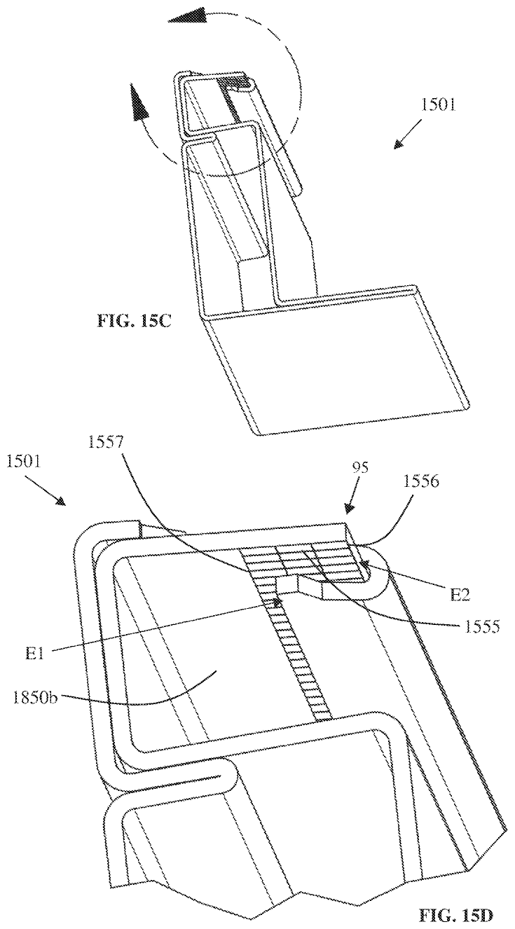

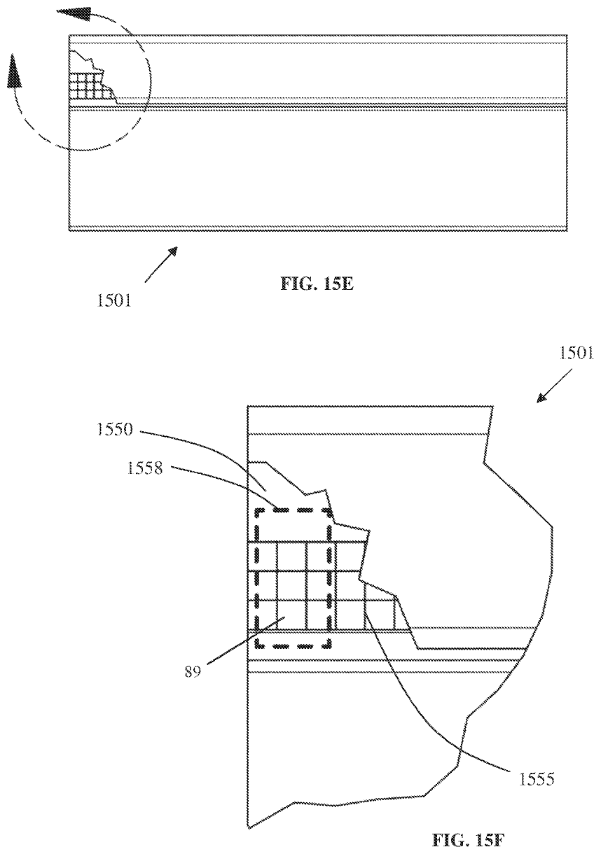

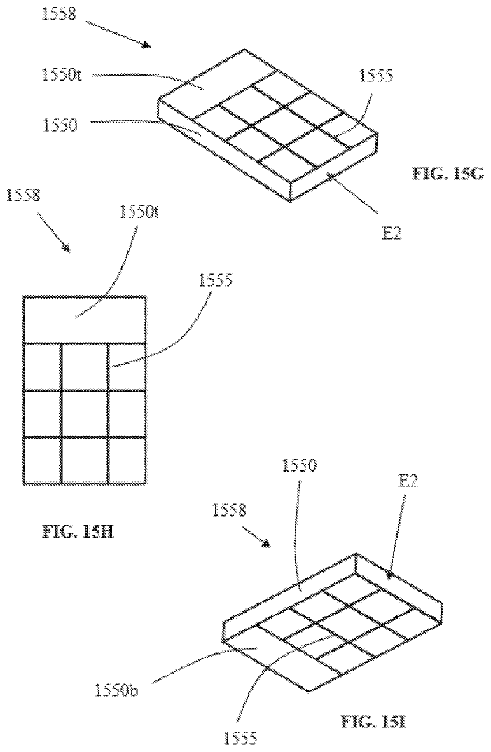

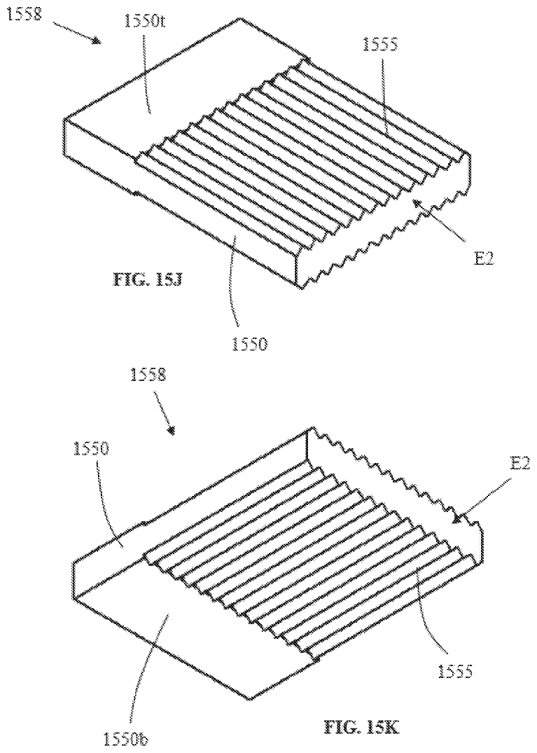

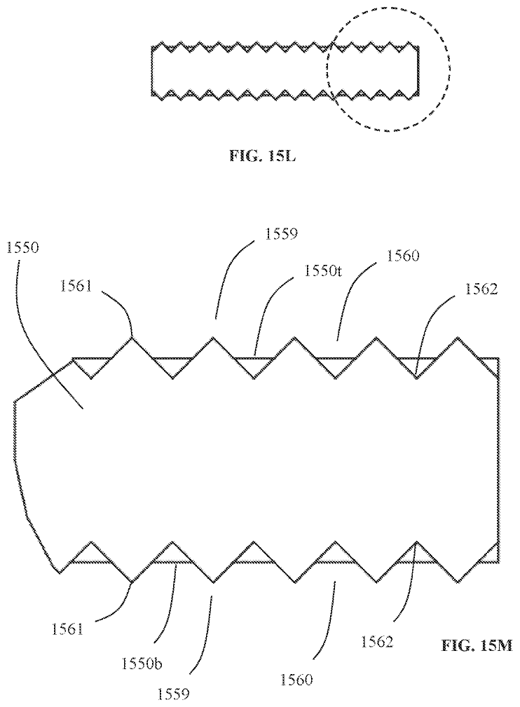

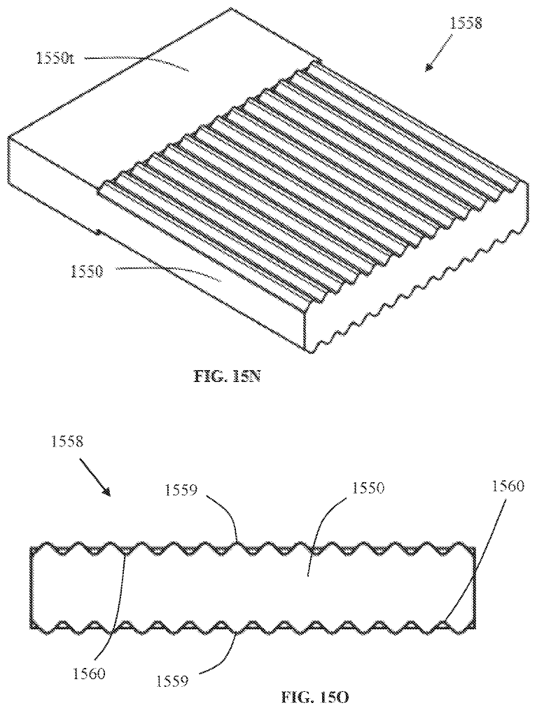

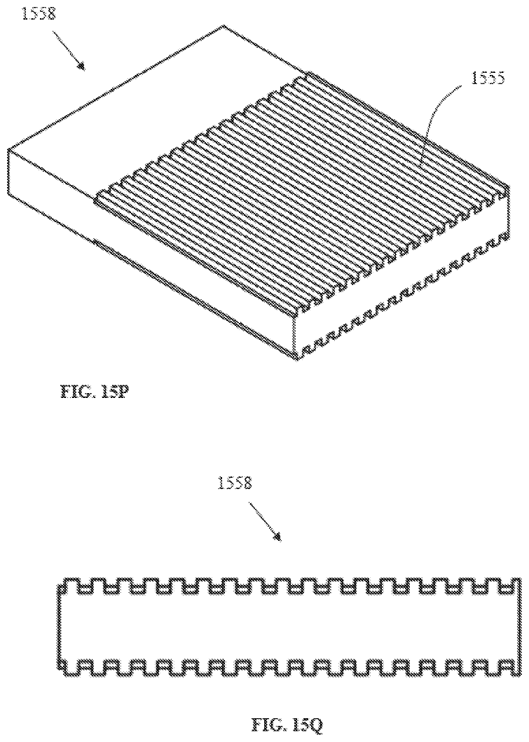

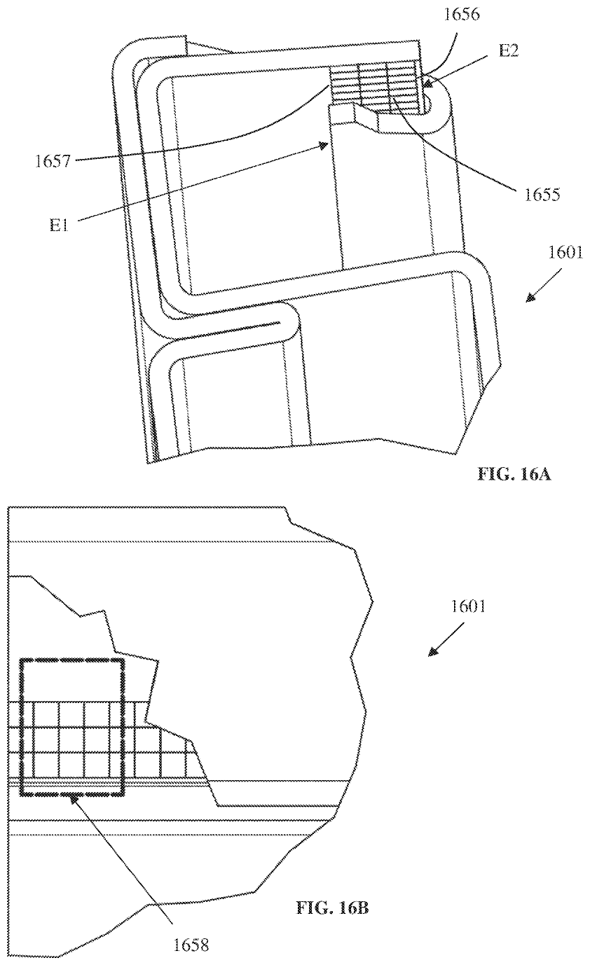

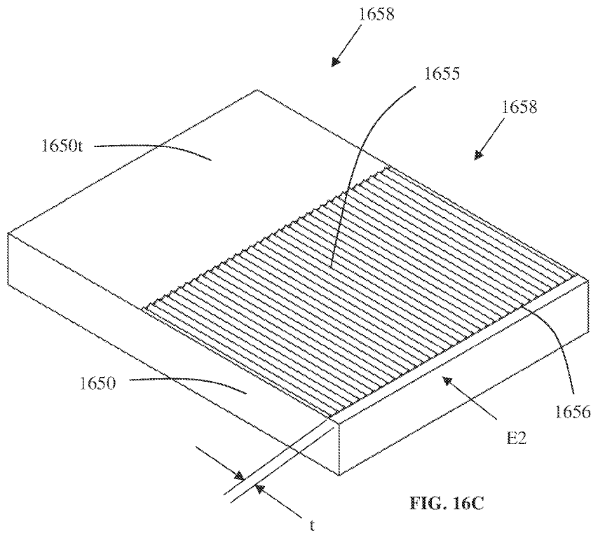

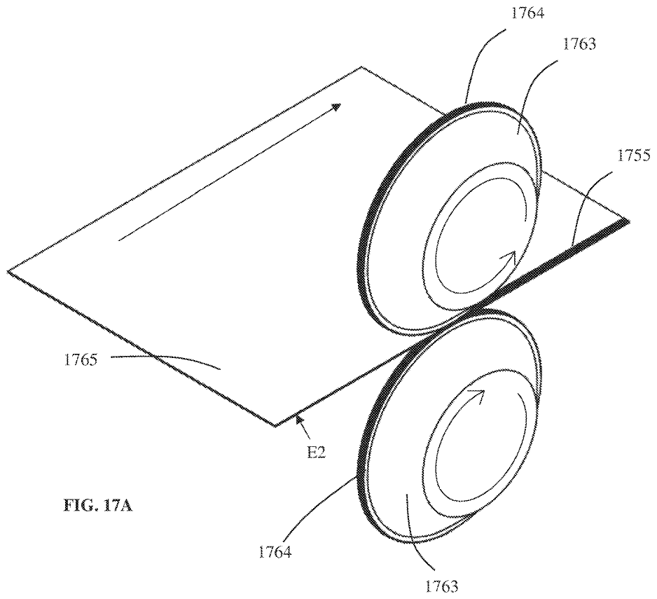

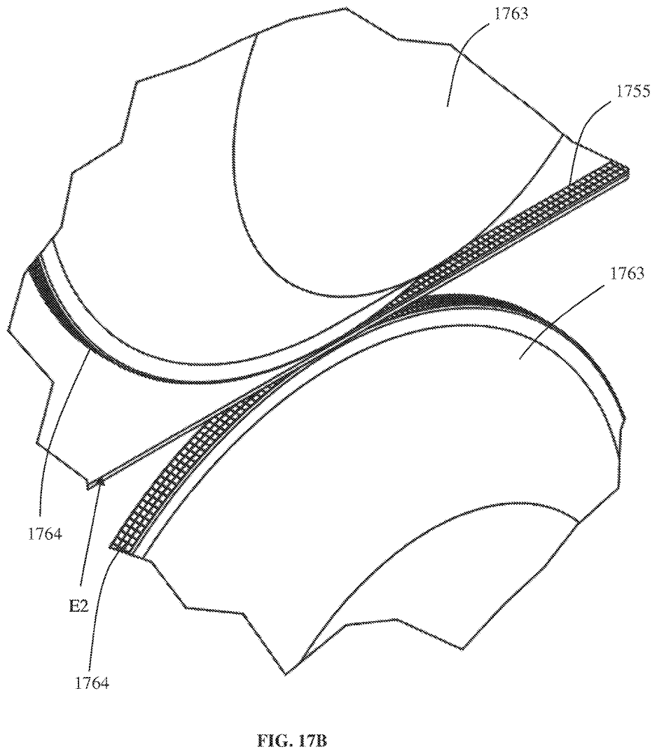

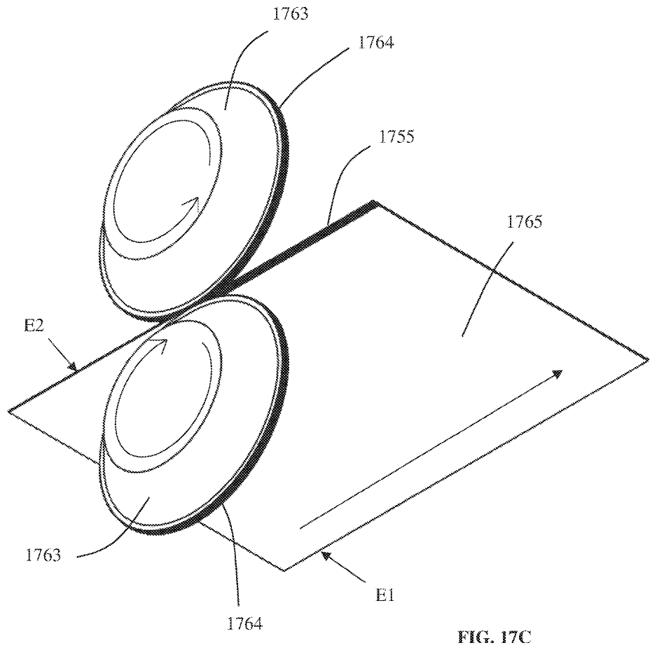

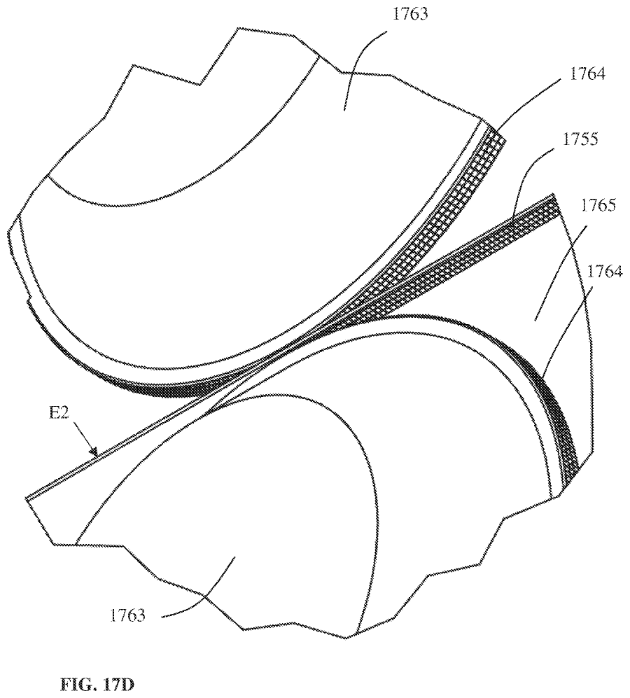

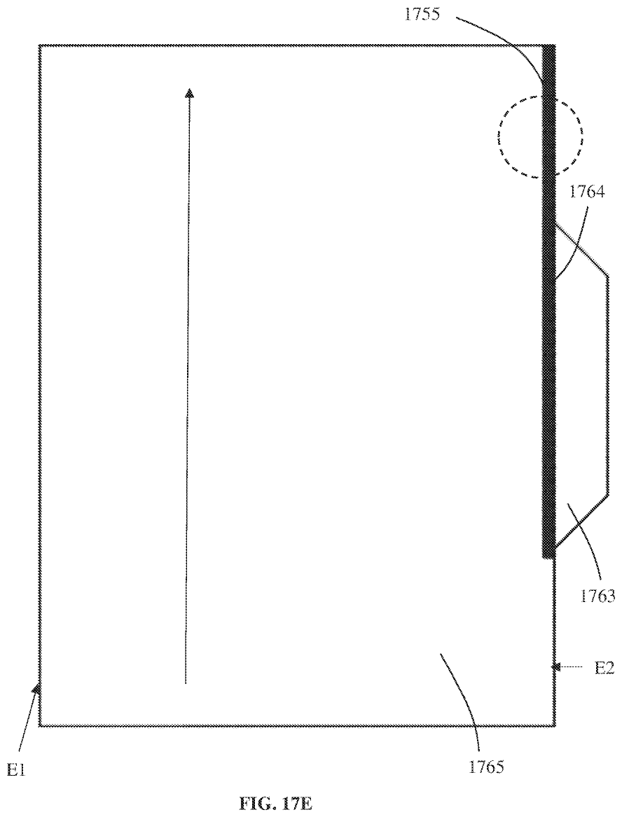

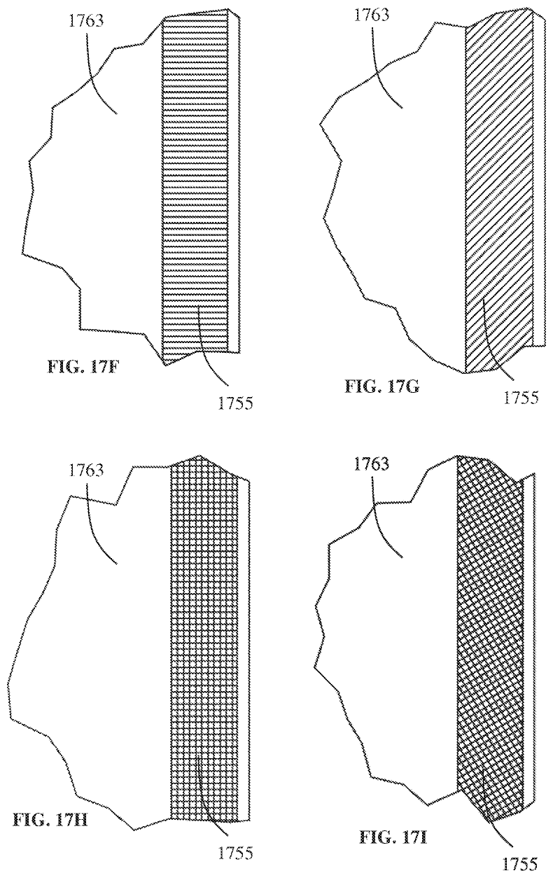

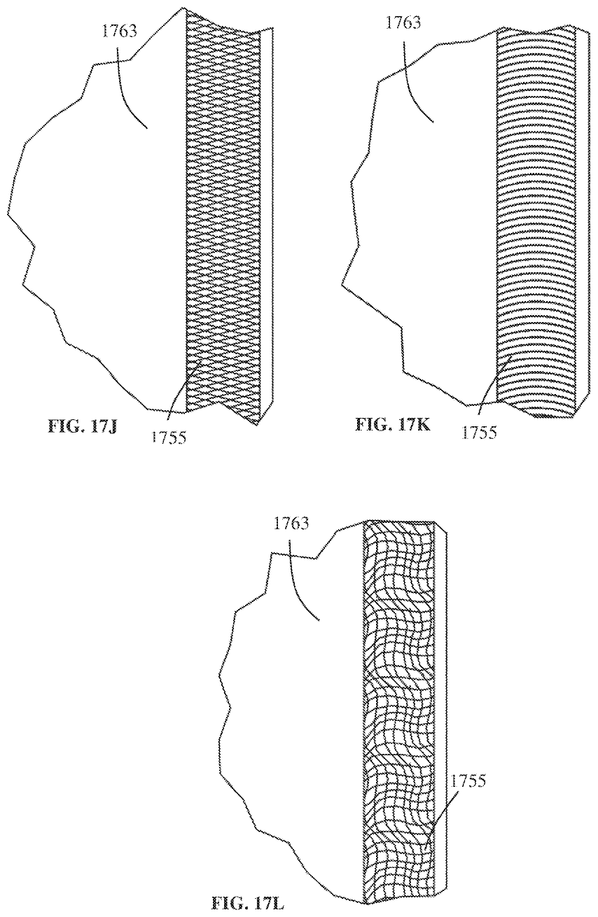

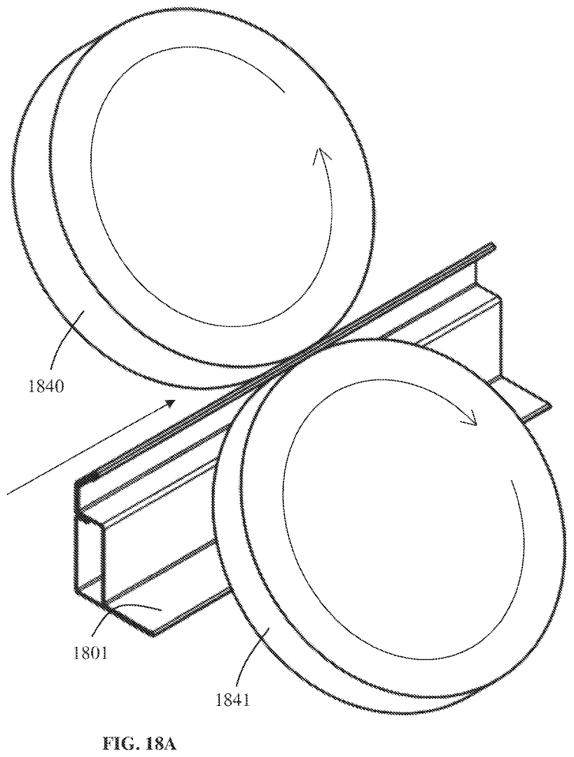

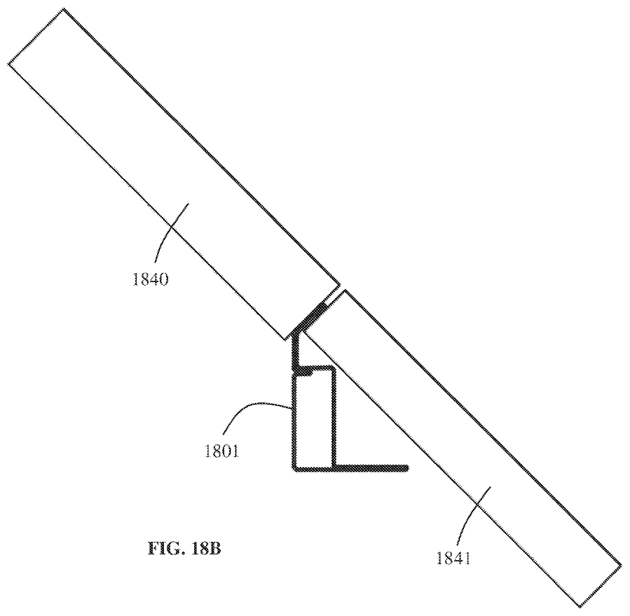

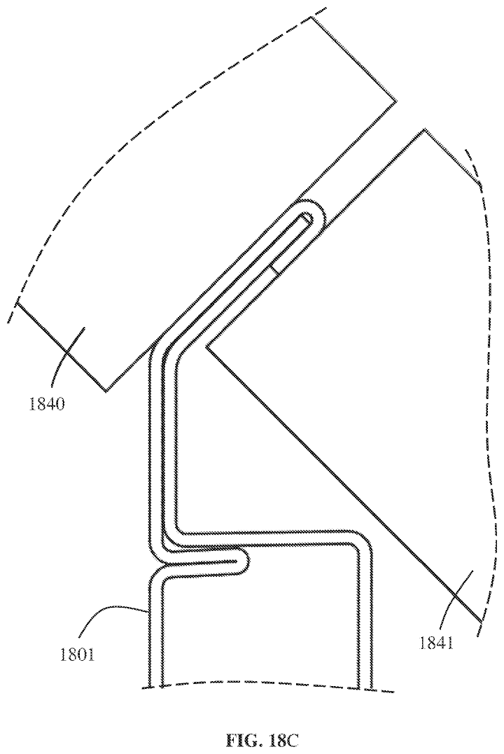

FIG. 15P shows a perspective view of some non-limiting examples of top lip layer coupons having locking features according to some embodiments.

FIG. 15Q shows an end plan view of some non-limiting examples of top lip layer coupons having locking features according to some embodiments.

FIG. 16A is a bottom perspective view of some non-limiting examples of a frame section having locking features according to some embodiments.

FIG. 16B is a bottom plan view which shows the sectioned top lip layer coupon cut out area.

FIG. 16C shows a perspective view of some non-limiting examples of top lip layer coupons having locking features according to some embodiments.

FIG. 17A shows a top perspective view of some non-limiting examples of pattern rollers forming locking features on strip sheet according to some embodiments.

FIG. 17B is an enlarged perspective view of FIG. 17A.

FIG. 17C shows a bottom perspective view of some non-limiting examples of pattern rollers forming locking features on strip sheet according to some embodiments.

FIG. 17D is an enlarged perspective view of FIG. 17C.

FIG. 17E shows a top plan view of some non-limiting examples of pattern rollers forming locking features on strip sheet according to some embodiments.

FIGS. 17F-17L show an enlarged top plan of view of 17E showing some non-limiting locking features according to some embodiments.

FIG. 18A shows a perspective view of rollers embedding a frame section's locking features into the top lip layers according to some embodiments.

FIG. 18B shows a side plan view of rollers embedding a frame section's locking features into the top lip layers according to some embodiments.

FIG. 18C is an enlarged perspective view of FIG. 18B.

### MODE(S) FOR CARRYING OUT THE INVENTION

It should be understood that embodiments include a variety of aspects, which may be combined in different ways. The following descriptions are provided to list elements and describe some of the embodiments of the present application. These elements are listed with initial embodiments; however, it should be understood that they may be combined in any manner and in any number to create additional embodiments. The variously described examples and embodiments should not be construed to limit embodiments of the present application to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

It is to be understood that the drawings are for purposes of illustrating the concepts of the disclosure and may not be to scale. Additional details of certain embodiments of the present application may be found in co-pending PCT application PCT/US2020/037092 filed on Jun. 10, 2020, co-pending U.S. provisional application 63/176,803 filed on Apr. 19, 2021, co-pending U.S. provisional application 63/176,824 filed Apr. 19, 2021, co-pending U.S. provisional application 63/189,591 filed May 17, 2021, co-pending U.S. provisional application 63/213,541 filed Jun. 22, 2021, co-pending U.S. provisional application 63/224,271 filed Jul. 21, 2021, and co-pending U.S. provisional 63/272,086 filed Oct. 26, 2021, co-pending U.S. provisional 63/272,086 filed Oct. 26, 2021, co-pending U.S. provisional 63/392,242 filed Jul. 26, 2022, co-pending U.S. provisional 63/399,711 filed August. 21, 2022, co-pending PCT application PCT/US2022/025383 filed April. 19, 2022, co-pending PCT application PCT/US22/25388 filed April. 19, 2022, co-pending PCT application PCT/US2022/0269668 filed May. 17, 2022, co-pending PCT application PCT/US2022/34278 filed June. 21, 2022, the entire contents of each application are incorporated herein by reference for all purposes.

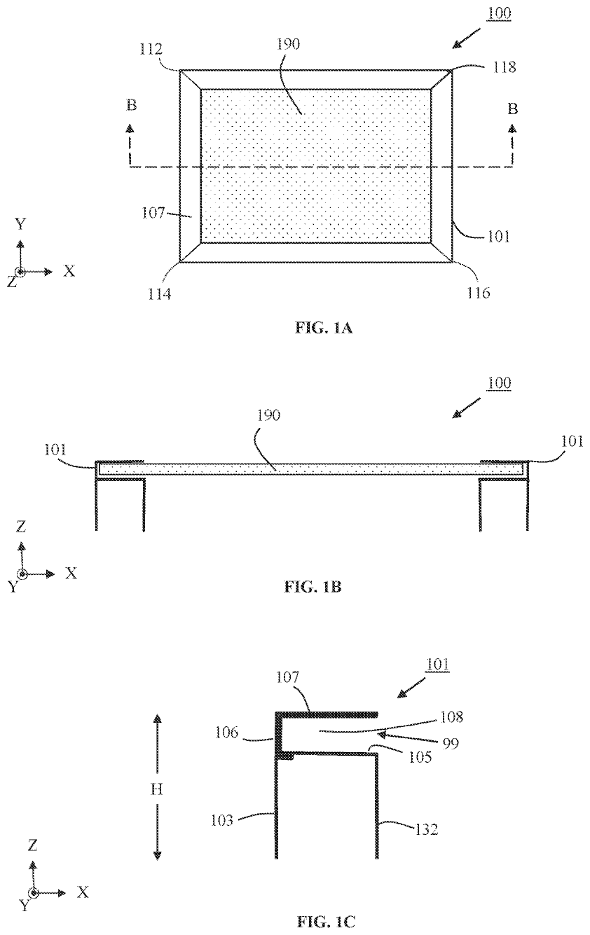

FIG. 1A is a plan view of a non-limiting example of a framed panel structure 100 (e.g., a framed solar panel structure or PV module) including panel 190 (e.g., a solar panel) encased in a frame 101 according to some embodiments. FIG. 1B is a cross-sectional view of the framed panel structure 100 along cutline B-B. For added perspective, XYZ coordinate axes are also shown. FIG. IC is the cross-sectional view as in FIG. 1B but excluding the panel to further illustrate some of the features of the frame 101.

In some embodiments and as discussed in more detail herein, frame 101 may be formed from substantially a single frame precursor structure that is bent in predetermined regions to accommodate three corners of the solar panel, perhaps with the fourth corner forming a joint between two ends of the frame precursor structure. That is, frame 101 may include a first corner bend 112 corresponding to a first corner of panel 190, a second comer bend 114 corresponding to a second corner of panel 190, a third corner bend 116 corresponding to a third corner of panel 190, and a corner joint 118 corresponding to a fourth corner of panel 190

Referring to FIGS. IB and IC, frame 101 may include a framework material that has been cut and folded into a desired shape. Frame 101 may be characterized by a height H and may include a lengthwise fold 102 defining an intersection of a frame sidewall 103 with a bottom flange 104. The frame may further include a series of folds to form a panel containment structure 99 including a lower shelf 105, a pocket wall 106, a top lip 107, and perhaps even a pocket region 108. In some embodiments, the bottom flange may generally represent, or be provided at, the base of the frame or framed panel structure. The panel 190 may be received into a portion of the pocket region and secured in place, optionally with a sealant that may have adhesive properties (not shown). Some non-limiting examples of sealants may include curable liquid silicone, urethane, epoxy, resin, any other liquid seal, or the like. Alternatively, or in combination, a pressure sensitive adhesive tape may optionally be used to secure the panel in the pocket region. In some embodiments, a panel containment structure may include only a lower shelf, or alternatively, only a lower shelf and a pocket wall. In such embodiments, the panel may optionally be secured in place using a sealant or pressure sensitive adhesive as described above. In some embodiments, only some of the frame sections may include a panel containment structure, for example, only frame sections on one set of opposing sides of a rectangular or square panel.

Although FIGS. 1B and 1C show non-limiting examples where the bottom flange, the lower shelf, and the top lip all extend away from the frame sidewall to an equal extent, any of these features may be shorter or longer than the others. The angle between the frame sidewall and bottom flange is shown to be approximately 90°, e.g., in a range of about 85° to about 95°, but in some other embodiments, the angle may be outside of that range, e.g., in a range of about 45° to about 135° depending on other features of the structure and overall system design. In some embodiments, the lower shelf and bottom flange may remain approximately parallel, e.g., within about 40°, alternatively within about 30°, 20°, 150, 10°, or 5°, regardless of the angle between the frame sidewall and the bottom flange. The top lip is shown to be parallel with the lower shelf, but in some embodiments, it may be at a slight angle or curved at the end so that the opening of the pocket region is larger or smaller than the pocket wall. In the embodiment illustrated in FIGS. 1B and 1C, the lower shelf 105 is shown as being formed from, or including multiple layers of, framework material. In some embodiments, any or all of the other frame features (e.g., the sidewall, bottom flange, pocket wall, upper lip, or the like) may be formed from or include multiple layers of framework material. In some cases, multiple layers may provide increased strength to the frame.

FIGS. 1A, 1B, and 1C illustrate a conventional rectangular panel shape that may be common for solar panels. However, there is no particular limitation on the shape of the panel which may be any polygon having 3, 4, 5, 6 7, 8 or more sides. The sides of the polygon may have the same length, or alternatively some sides may be longer or shorter. The corner angles of the polygon may all be the same, or alternatively, some corner angles may have smaller or larger angles than others. Although frames and frame sections herein are generally shown as having a bottom flange, in some embodiments, one or more frame sections may not include a bottom flange. In some embodiments where the frame has a rectangular shape, the frame sections corresponding to the shorter sides of the frame may not include a bottom flange whereas the frame sections corresponding to the longer sides of the frame may include a bottom flange.

Making the frame or a frame section substantially from a single piece of framework material may have considerable manufacturing, assembly, and cost advantages. However, the panel containment structure in some embodiments may be formed using alternative methods and materials. For example, the shelf may be a piece of shelf material bonded (e.g., welded, brazed, soldered, glued, or the like) to an upper portion of the frame sidewall. Similarly, the top lip may include a piece of top lip material bonded to the top of the frame structure. Alternatively, the entire panel containment structure may be a separate structure designed to sit on, slip over, or otherwise mate with the frame sidewall. As discussed elsewhere herein, rather than one elongated piece of framework material, a 4-sided frame may be formed from 2, 3, or even 4 frame separate frame sections (or more if the frame has more than 4 sides). Although not illustrated in FIGS. 1A-1C , the frame or framed panel structure may further include a support wall extending from the bottom flange to the panel containment structure or to the frame sidewall, as described in more detail below. It should be noted that, throughout this disclosure, the terms “upper portion” and “top lip” may in some cases refer to general positions relative to the bottom flange or the base of the frame, and does not necessarily indicate a position or orientation in the final framed panel structure, which may be oriented in a manner other than horizontal as shown in FIG. IB (e.g., at an angle, on its side, or even parietally or fully inverted).

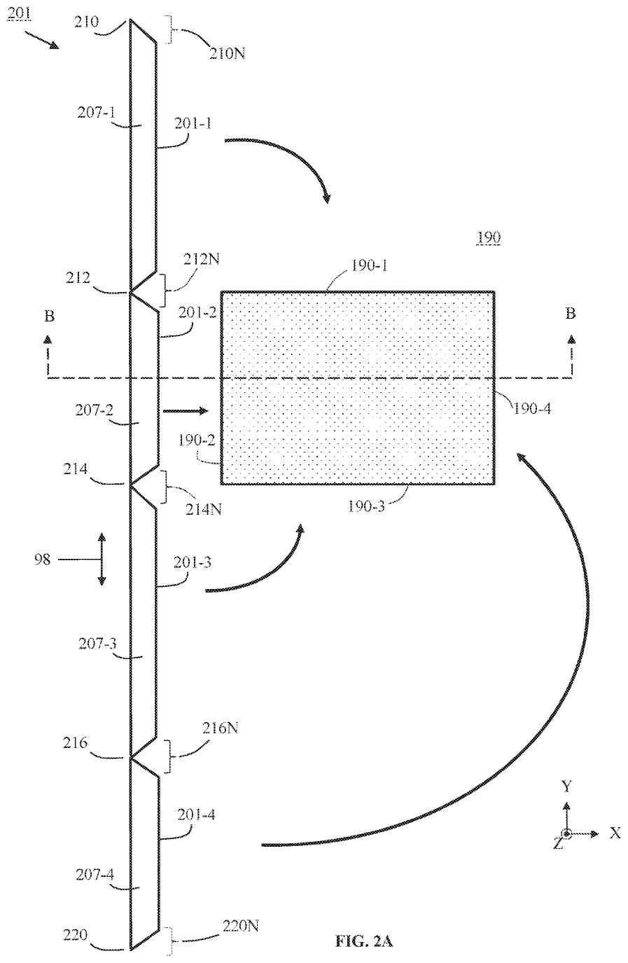

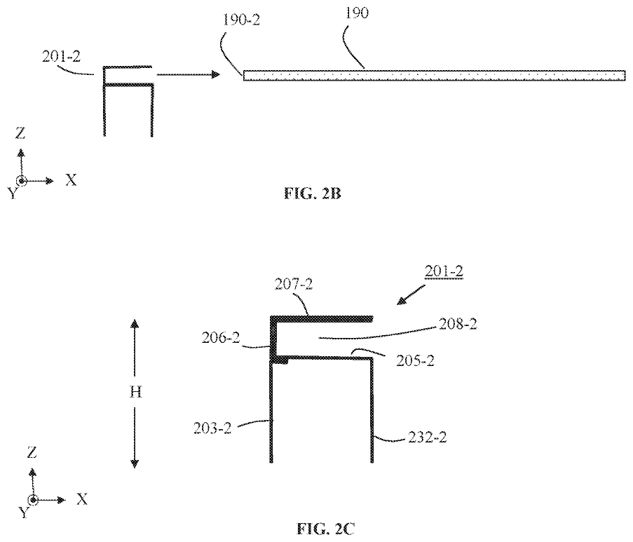

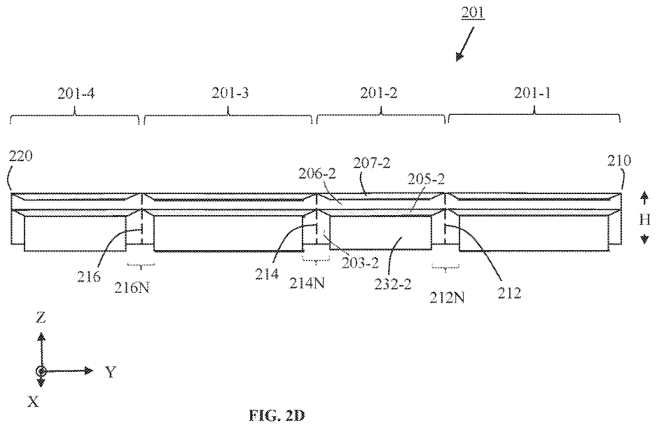

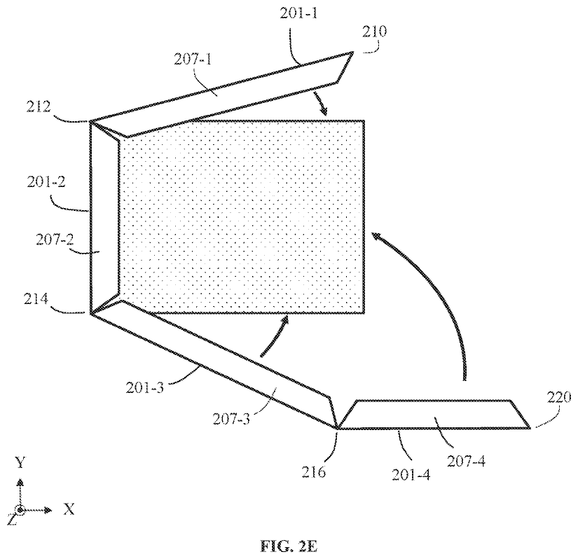

FIG. 2A is a plan view schematic to generally illustrate construction of a framed panel structure according to some embodiments. FIG. 2B is a cross-sectional view of FIG. 2A along cutline B-B. A frame precursor structure 201 may be formed from framework material characterized by an average thickness. Frame precursor structure 201 may include a first end 210 and a second end 220 defining a lengthwise dimension 98. The frame precursor structure 201 may include a first frame section 201-1 designed to fit with or attach to first panel edge 190-1 of panel 190, a second frame section 201-2 designed to fit with or attach to second panel edge 190-2, a third frame section 201-3 designed to fit with or attach to third panel edge 190-3, and even a fourth frame section 201-4 designed to fit with or attach to fourth panel edge 190-4. Frame precursor structure 201 may include a first corner bend precursor axis 212 between the first and second frame sections and may be designed to bend along the Z axis (the height axis) of the frame sidewall. In a finished framed panel structure, first corner bend precursor axis 212 can correspond to first corner bend 112 (FIG. 1A). Similarly, frame precursor structure 201 may include second and third corner bend precursor axes 214 and 216, respectively.

Referring to FIG. 2B, the cross-sectional structure correlates to that of FIG. IB for the finished frame. FIG. 2C is the cross-sectional view as in FIG. 2B but excluding the panel to further illustrate some non-limiting examples of the features of the frame precursor structure, in particular, frame section 201-2. Here, second frame section 201-2 may be characterized by height H and may include a lengthwise fold 202-2 perhaps defining an intersection of a frame sidewall 203-2 with a bottom flange 204-2. The second frame section may include a series of folds to form a panel containment structure including a lower shelf 205-2, a pocket wall 206-2, a top lip 207-2 and perhaps even a pocket region 208-2. In some embodiments, the bottom flange may generally represent, or be provided at, the base of the frame section. The panel 190 may be received into a portion of the pocket region and secured in place, optionally with some sealant (not shown). In some embodiments, each frame section of the frame precursor structure may have substantially the same cross-sectional structure as shown for the second frame section 201-2 in FIG. 2B. But in some other embodiments, there may be differences between cross-sectional structures of two or more of frame sections. In the embodiment illustrated in FIGS. 2B and 2C, the lower shelf 205-2 is shown as being formed from, or including multiple layers of, framework material. In some embodiments, any or all of the other frame section features (e.g., the sidewall, bottom flange, pocket wall, upper lip, or the like) may be formed from or include multiple layers of framework material. In some cases, multiple layers may provide increased strength to the frame.

In order to accommodate bending of the frame precursor structure to enclose the panel, the frame precursor structure may include a series of notches (212N, 214N, 216N) in the top lip, the lower shelf, and even the bottom flange, such notches corresponding to first, second, and third corner bend precursor axes, 212, 214, and 216, respectively. In FIG. 2A, the notches are only visible in the top lip (between top lip 207-1 and top lip 207-2, between top lip 207-2 and top lip 207-3, and between top lip 207-3 and top lip 207-4), but similar notches may also be present in the lower shelf and bottom flange. In some embodiments, the angle of the notch may be about 180° minus the angle of the panel corner being enclosed. Similarly, the ends of the frame precursor structure may also include an angled cut (210N and 220N) in the top lip, the lower shelf, and the bottom flange to accommodate formation of a corner joint.

In FIG. 2D, there is shown a non-limiting example of a side view schematic (with slight elevation) of the frame precursor structure facing the side that can receive the panel. For clarity, not all of the features are labelled, but in combination with the other figures, the identity of each feature is self-evident.

Referring to FIG. 2E, there is a plan view showing a non-limiting example of an intermediate state of assembling the framed panel structure where the frame precursor structure has received the panel edge 190-2 into frame section 201-2 and bends are being formed along the bend precursor axes as other frame sections move closer to their intended final positions around the panel. Note that assembly does not have to start with panel edge 190-2 but may instead start with any panel edge or corner. Forming the corner joint 118 where the two ends (210 and 220) of the frame precursor structure meet may be a final step in this portion of the framed panel structure assembly, but there may be additional steps to further secure or modify the frame (e.g., adding optional support brackets, tightening optional bolts, or the like). In some embodiments, assembling the framed panel structure may include use of an assembly apparatus that holds and manipulates the panel and frame precursor structure(s). With respect to orientation of the components during assembly relative to the assembly apparatus, the plan view of FIG. 2E may represent a view from above, or alternatively a view from below, or even a view from the side, depending on the nature of the assembly apparatus.

In some embodiments, the corner bends and/or corner joints may include features capable of forming interlocking structures. For example, a bottom flange or other portion on one side of the corner may include a locking element that may be received into an opening on the other side of the corner.

Although not illustrated in FIGS. 2A-2E , one or more frame sections may further include a support wall extending from the bottom flange to the panel containment structure or to the frame sidewall, as described in more detail below.

In some embodiments, the frame precursor structure 201 may be substantially linear (as shown) prior to assembling the framed panel structure. In some embodiments, the frame precursor structure may be received by an assembler already partially bent at one or more corner bend precursor axes. One or more corner bend precursor axes may be pre-scored or include a furrow or features that promote bending along the height access between the frame sections. The frame and frame precursor structures described in FIGS. 1A-C and 2A-E are non-limiting examples provided in order to illustrate how some of the frame support structures described below may be implemented in a frame. Alternative designs and structures may be used effectively with such support structures. In some embodiments, rather than using one frame precursor structure, multiple frame precursor structures may be used to enclose a panel. For example, with a rectangular panel, two similar frame precursor structures, each having one corner bend precursor axis may be used to form a framed panel structure that may include two corner joints at opposite corners and two corner bends at opposite corners. Alternatively, a first frame precursor structure may have two corner bend precursor axes and a second frame precursor structure may have no corner bend precursor axes and be used to form a framed panel structure that may include two corner joints at adjacent corners and two corner bends also at adjacent corners. Alternatively, three frame precursor structures may be used where one may have one corner bend precursor axis and the other two may not, whereby a framed panel structure may include one comer bend and three corner joints. Alternatively, four frame precursor structures may be used wherein none have a corner bend precursor axis and the framed panel structure may include four corner joints.

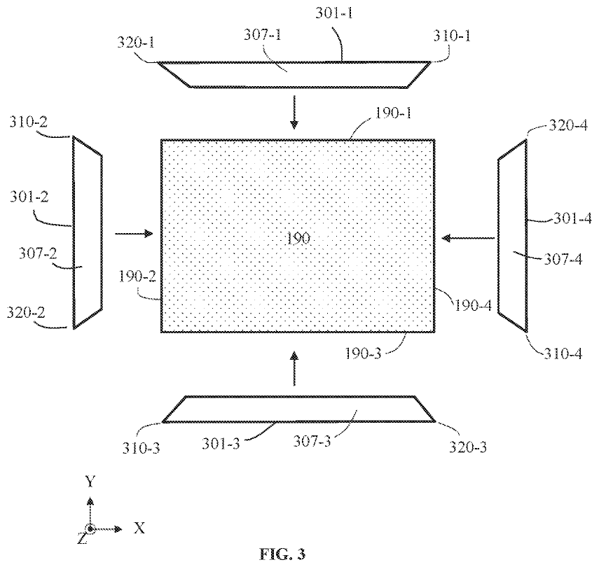

FIG. 3 is a plan view showing a non-limiting example of assembling a frame using four frame precursor structures according to some embodiments. Each frame precursor structure (each of which may also be referred to herein as a frame section) 301-1, 301-2, 301-3, 301-4 may optionally include any of the features described above, such as a bottom flange, a side wall, and even a panel containment structure that may include a lower shelf, a pocket wall and a top lip. In some cases, one or more frame sections may further include a support wall extending from the bottom flange to the panel containment structure or to the frame sidewall. In this view, only the top lip 307-1, 307-2, 307-3, 307-4 of each frame precursor structure is visible. Each frame precursor structure may have a first end 310-1, 310-2, 310-3, 310-4 and a second end 320-1, 320-2, 320-3, 320-4. When assembled, a first end of one frame precursor structure may form a corner joint with a second end of an adjacent frame precursor structure. As discussed with respect to FIG. 2E, the plan view of FIG. 2E may represent a view from above, or alternatively a view from below, or even a view from the side, depending on the nature of the assembly apparatus.

As indicated by the arrows, a first frame precursor structure may be designed to fit with or attach to a first panel edge 190-1 of panel 190, a second frame precursor structure 301-2 may be designed to fit with or attach to a second panel edge 190-2, a third frame precursor structure 301-3 may be designed to fit with third panel edge 190-3, and even a fourth frame precursor structure 301-4 may be designed to fit with fourth panel edge 190-4. There are numerous variations regarding the sequence used to assemble the frame. In some embodiments, all four frame precursor structures are concurrently brought together with their respective panel edges and attached at approximately the same time. In some cases, attachment is sequential and may be in any order. In some embodiments, just two or three frame precursor structures are concurrently brought together with their respective panel edges and the remaining frame precursor structures are attached later or already pre-attached. In some embodiments, two or three of the frame precursor structures may be first attached to each other via a corner joint and then attached to the panel. In some cases, a frame precursor structure may initially be brought together with its respective panel edge at an angle rather than flush or parallel. In some cases, the choice of assembly sequence may in part be dependent upon the design of the corner joint to be used. In some embodiments, corners joint connection may, for example, be made using clinching, rivets, screws, nuts/bolts, welding, adhesives, or the like. In some cases, corner joint connections may be made using a tab connection assembly or any of the other connection structures and methods discussed in U.S. Provisional Patent Application 63/272,086 filed Oct. 26, 2021.

In some embodiments, a finished frame (whether made from a continuous piece or from multiple frame section pieces) may further include one or more cross bars that may extend from one frame section to an opposite or adjacent frame section. In some embodiments with respect to a rectangular frame, a cross bar may extend between the two longest opposing frame sections. In some cases, a cross bar may connect two opposing frame sections at about their middle areas. Cross bars may act to strengthen the frame. A cross bar may be connected to the frame at the bottom flange, a frame sidewall, or at some other frame feature including, but not limited to, support walls (discussed below). In some embodiments, a cross bar structure may include an upper surface upon which the panel may rest or optionally be adhered to. In some cases, cross bars may be readily attached as part of the panel mounting process (e.g., as discussed in FIGS. 2E and 3). That is, an additional separate step may not be needed in some cases. In some embodiments, the cross bars may be formed of the framework material used for the rest of the frame. In some embodiments, the cross bars may use a different material

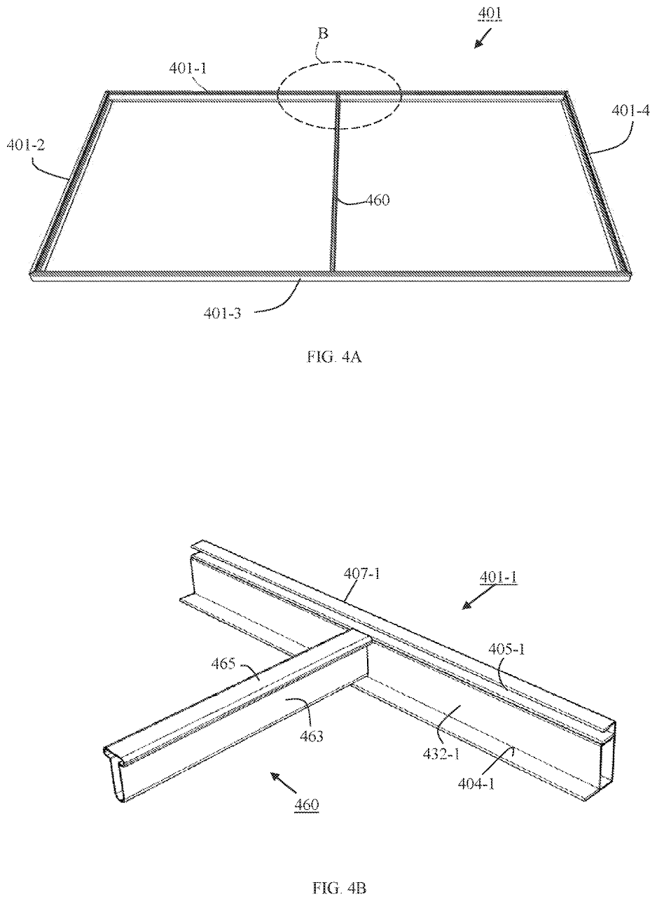

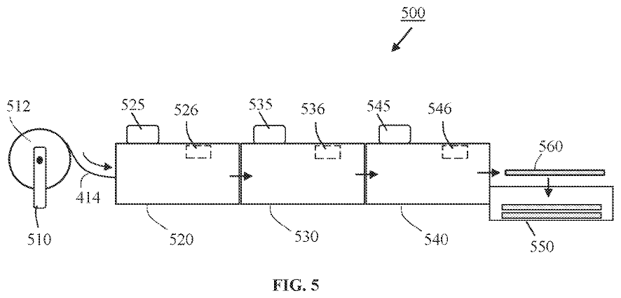

FIG. 4A is a perspective view of a non-limiting example of a frame that includes a cross bar according to some embodiments. For clarity, the framed panel is not shown. In some cases, frame 401 may include a first frame section 401-1, second frame section 401-2, third frame section 401-3, and fourth frame section 401-4. Cross bar 460 may be connected to opposing frame sections 401-1 and 401-3. In some embodiments, connection may, for example, be made using clinching, crimping, rivets, screws, nuts/bolts, welding, adhesives, or the like. In some cases, connections may be made using a tab connection assembly or any of the other connection structures and methods discussed in U.S. Provisional Patent Application 63/272,086 filed Oct. 26, 2021.

FIG. 4B is a zoomed in view of area B from FIG. 4A. In some cases, first frame section 401-1 may optionally have a box frame structure as described below. Frame section 401-1 may, for example, include a bottom flange 404-1, a support wall 432-1 lower shelf 405-1, top lip 407-1, and frame sidewall (not visible in this view). In some embodiments cross bar 460 may include a cross bar top surface 465 and cross bar sidewall 463. Cross bar 460 may optionally have a box type of structure including another sidewall (not visible in this figure) opposite cross bar sidewall 463 and a bottom flange or bottom surface (not visible in this figure) opposite cross bar top surface 465. In some cases, the cross bar top surface 465 may contact the panel and may optionally include an adhesive layer to help secure the panel. In some embodiments, the cross bar top surface 465 may be flush (at the same height) with lower shelf 405-1 of the first frame section. In some embodiments, cross bar 465 may be connected to the first frame section at the frame sidewall, bottom flange, support wall, or any combination.

The framework material should have sufficient strength to support the panel. In some embodiments, the framework material may include a metal such as uncoated steel, coated steel, stainless steel, aluminum, or another metal or metal alloy (coated or uncoated), or the like. In some embodiments, the framework material may be a coated metal such as coated steel or the like that includes an anti-corrosion coating or treatment. For example, coated steel may include metallic-coated steel, organic-coated steel, or tinplate. Some non-limiting examples of metallic coatings for steel may include zinc and zinc alloys (e.g., a Zn—Al alloy), aluminum, and magnesium. Depending on the coating, such metallic coatings may be applied by hot dip galvanization, electro-galvanizing, thermal spray, or the like. Some non-limiting examples of organic coatings may include polyesters or PVDF, which may be applied from a paint or other coatable mixture. Tinplate may be made by coating tin onto the cold-rolled steel, e.g., by electroplating. In some embodiments, the thickness of coated steel for use as a framework material may be in a range of about 0.5 to about 0.6 mm, alternatively about 0.6 to about 0.7 mm, alternatively about 0.7 to about 0.8 mm, alternatively about 0.8 to about 0.9 mm, alternatively about 0.9 to about 1.0 mm, alternatively about 1.0 to about 1.2 mm, alternatively about 1.2 to about 1.4 mm, alternatively about 1.4 to about 1.6 mm, alternatively about 1.6 to about 1.8 mm, alternatively about 1.8 to about 2.0 mm, or any combination or permutation of ranges thereof. When a coated steel framework material may be used to make a frame for a conventional photovoltaic solar panel, in some embodiments, the thickness may be in a range of about 0.7 to about 1.4 mm.

In some embodiments, steel may be a steel other than stainless steel. For some applications, e.g., for photovoltaic solar panels, steel may have a useful combination of technical and commercial benefits. Steel can have properties that may be applied in the material selection, fabrication, and long-term durability that are useful to the form and function of the frame or frame precursor structure product. During preproduction, steel may be readily coated with anti-corrosion coatings employing multiple chemistries that offer corrosion resistance which can be beneficial to the durability of the frames. Steel may be painted with clear or specific colors that may optionally allow identification of a specific module selection of various categories. Because painting or anti-corrosion coatings may be applied in high-speed manufacturing formats, the cost and durability are more effective than most other metals. Steel may optionally be both painted and have anti-corrosion coatings, allowing for multiple benefits to the branding, module identification, and long-term maintenance over non-steel module frames.

Steel is a highly durable material that may be significantly deformed while retaining its toughness and resistance to structural failure. The properties of toughness while being deformed may be referred to as ductility. Due to the ductility of steel, it may be shaped starting from a thin sheet of material, e.g., wrapped around a coil, which may be fed directly into a punching station that may employ a variety of methods to cut or partially cut or create grooves in the face of the steel sheet. Following this process, the steel which has been modified in the punching station may be fed into a linear and non-linear set of rollers which can deform the steel sheet into a new profile, of which many variations are possible. Due to the ductility of steel, this process may be performed at high speed, with production speeds from less than about 0.1 meters/second to over about 4.0 meters/second. Steel's compatibility with this high-speed forming process may provide significant manufacturing cost advantages. Due to steel's ductility, it may be bent into simple or complex shapes that will retain their relative shape or position for the life of the product. In some embodiments, steel that has been shaped into simple or complex forms may also be designed to yield or partially yield at specific locations or along a predetermined path as part of intended installation or operational parameters.

Steel has electrical properties which may allow it to act as a code-approved path of intended electricity, such as to create an electrical ground or electrical bonding. Due to the properties of steel and the potential anti-corrosion or paint coatings available, the electrical ground or electrical bonding may still occur without the need for additional hardware or devices. When steel module frames are attached directly to a steel structure, most electrical codes allow for this connection to be considered a competent electrical ground or electrical bond. This means that the framed panel structures may connect directly to a steel substructure, and may be considered to have achieved sufficient electrical ground or electrical bond sufficient to meet code, with or without addition of hardware, as part of the module-to-substructure attachment.

Steel's magnetic properties may allow for special features and benefits through the use of magnetic steel frames. The magnetic properties of steel may allow for simple attachments of appurtenances utilizing few or no added hardware. Steel's magnetic properties may allow for sensory devices to collect useful data during the manufacture of a frame precursor structure or data regarding a panel installation. Steel's magnetic properties may allow for robot sensors to be used to assist in the proper installation or deinstallation of panel modules. Steel's magnetic properties may allow the easy attachment or pre-attachment of hardware of various sorts to the module frame to facilitate installation of additional equipment.

In some cases, the frame precursor structure may be fabricated from an elongated sheet of the framework material that is bendable and cuttable. The elongated sheet may be cut, for example, using a water cutter, a laser, a punch, a saw, or the like, depending on the framework material. The cuts may be used to form some of the various features described herein such as notches, holes, furrows or other features. After at least some of the cuts have been made, the clongated sheet may be folded to form at least a portion of the frame precursor structure. Such folding may include, but is not limited to, roll forming. In some embodiments, the cutting and folding processes may be applied to a coated steel-based framework material.

FIG. 5 is block diagram showing a non-limiting example of a manufacturing process line for making frame precursor structures according to some embodiments. Manufacturing process line 500 may include a framework material station 510 having framework material that may be fed into the next station. In some embodiments, the framework material may be in the form of sheets that are pre-cut to the final desired length. In some embodiments, the framework material may be fed continuously to the next station. For example, framework material station 510 may include a coil 512 of coated steel 514. The coated steel 514 may be supplied to punching station 520. For example, the punching station 520 may pull the coated steel 514 from the coil. In some embodiments, certain cutting and/or punching processes may be performed at punching station 520 to cut and/or remove predetermined sections of the framework material to make a patterned framework material. In some embodiments, the framework material may be cut to a desired length at the punching station, if such cut has not yet been performed. In some embodiments, the process may be controlled to high tolerances. Punching station 520 may include a microprocessor 525 and machine software and/or firmware that may control the cutting. Punching station 520 may include one or more sensors 526 that provide data to the microprocessor which may be used to monitor the punching processes or identify defects. The microprocessor 525 may be in electronic communication with another microprocessor or with an external computer for sending or receiving data or instructions. Such electronic communication may be through cables or wireless methods.

After the punching station 520, the patterned framework material, e.g., coated steel, may be received by a roll forming station 530. The steel may be shaped in a linear fashion using multiple rollers that provide a graduated bending process to form the steel into the desired shape (shaped framework material). The design of the rollers, order of the rollers, and tolerances may be highly precise, and may result in a fully (or nearly fully) shaped and punched frame precursor structure. Roll forming station 530 may include a microprocessor 535 and machine software and/or firmware that may control the roll forming. Roll forming station 530 may include one or more sensors 536 that provide data to the microprocessor which may be used to monitor the bending and folding processes or identify defects. The microprocessor 535 may be in electronic communication with another microprocessor or with an external computer for sending or receiving data or instructions. Such electronic communication may be through cables or wireless methods. In some embodiments, the framework material may be cut to a desired length at the roll forming station, if such cut has not yet been performed. In some embodiments, the roll forming station may include an adhesive applicator tool to apply an appropriate adhesive to a predetermined portion of the framework material while shaping framework material, e.g., to help the shaped framework material to maintain its shape.

After the roll forming station 530, the shaped framework material, e.g., coated steel, may be received by a post forming station 540. Some non-limiting examples of post forming processes may include cutting the frame precursor structures to length, buffing/deburring, cleaning, or passing the frame precursor structures through straightening rollers or dies that may ensure product accuracy. Post forming station 540 may include a microprocessor 545 and machine software and/or firmware that may control one or more post forming processes. Post forming station 540 may include one or more sensors 546 that provide data to the microprocessor which may be used to monitor the post forming processes or identify defects or out-of-tolerance parts. These data may be fed back to roll forming station 530 for active adjustment of roll forming rollers or adjustment rollers. Post forming station 540 may include a cleaning section. The microprocessor 545 may be in electronic communication with another microprocessor or with an external computer for sending or receiving data or instructions. Such electronic communication may be through cables or wireless methods.

After the post forming station 540, finished (or nearly finished) frame precursor structures 560 are received by a finished product station 550. The frame precursor structures may be loaded into transportation containers and prepared for delivery, e.g., to a solar panel module production facility.

In some embodiments, the framework material may proceed in a generally linear (forward) direction from one station to the next. In some embodiments, the direction of framework material may be temporarily reversed within a station, for example, to repeat a particular step. In some embodiments, there may be multiple punching stations, roll forming stations, and/or post forming stations.

For any of the aforementioned stations, the microprocessor(s) may provide control signals to electro-mechanical motors that may be responsible for moving the intermediate products along the manufacturing line. Depending upon the process to be performed on the intermediate products, software/firmware running on the microprocessor(s) may dictate various factors/parameters of production. For merely some non-limiting examples, a microprocessor may dictate the speed and/or direction of the intermediate products traversing a given station. In some embodiments, a microprocessor may dictate when and/or how the intermediate products are to be shaped, punched, cut or the like in order to affect the desired intermediate/final products. In some embodiments, a microprocessor may receive signals from one or more sensors for monitoring manufacturing progress, identifying defects or out-of-tolerance parts, or measuring some other useful property of intermediate products as they are made. For example, an optical or imaging sensor(s) may provide data that allows a microprocessor to assess manufacturing status and/or how well a particular production step was performed. In some embodiments, if quality is below standard, a microprocessor may send a status alert signal to a system operator and/or to another microprocessor. Other sensors may also be useful to monitor manufacturing status and/or quality control metrics. In addition to optical and imaging sensors, non-limiting examples of potentially useful sensors or their components may include laser-based sensors (including, but not limited, to laser position sensors), vision systems (including, but not limited to vision measurement and shape vision systems), contact sensors (including, but not limited to contact position sensors), vibration sensors, thermal sensors, conductivity sensors, roughness sensors, profilometers, ultrasonic sensors, stress sensors, and the like.

In some embodiments, the frame or framed panel structure may be attached to a support structure that may hold the frame or framed panel structure in a predetermined position. Such support structures and systems may take many forms, but some non-limiting examples may include racking, rail mounts, pole mounts, tracking mounts, or non-tracking mounts, or the like. In combination with a support structure, a frame or framed panel structure may be attached to its intended target, including but not limited to, to a building (e.g., a roof, a wall, an awning or the like), to the ground, to a shade structure or carport, or to a moving or stationary vehicle. In some embodiments, a frame or framed panel structure may be attached directly to its intended target without an intermediate support structure. In such case, the target itself may act as the support structure.

To provide robust support and strength to the framed panel such as a solar panel, it may be useful for the frame to include one or more connection features, for example, when forming a corner joint between frame precursor structures or sections. For the purposes of describing various connection features and technology below, the terms “frame precursor structure” and “frame sections” may be used interchangeably unless otherwise noted. In some cases, the frame may also include additional strengthening features such as cross bars that may extend from one frame section to an opposite or adjacent frame section. These additional strengthening features may also benefit from the use of one or more connection features. Similarly, in some embodiments, certain connection features may be used to attach a framed panel structure to a support structure such as racking.

In some embodiments, the frame or frame sections illustrated in FIGS, 1-3 may benefit from additional structural support features to improve the strength of the frame in some way to address various forces it may experience when used in a framed panel structure. For example, such additional support may enable the frame to hold larger panels (e.g., PV laminates), withstand greater environmental and/or handling forces (wind, snow, mounting, clamping, bending, torsional stresses or the like), or increase PV module lifetime by reducing the number or intensity or of stress points, or improving their distribution. In some cases, structural support features may enable the use of framework materials that are thinner, easier to handle, or less expensive.

In some embodiments a useful structural support feature may include a support wall extending (i) between the bottom flange and the frame sidewall, (ii) between the bottom flange and the lower shelf, or (iii) both (i) and (ii). In some cases, a frame or frame section including a support wall, bottom flange, sidewall, and lower shelf, may be advantageously produced from a single piece of framework material. In some cases, using a single piece of framework material for these features may simplify manufacturing thereby reducing costs and increasing throughput and yield. Such single piece manufacturing may also increase the lifetime of the frame by avoiding the many failure-prone attachments points that would be needed if these features were assembled from separate parts.

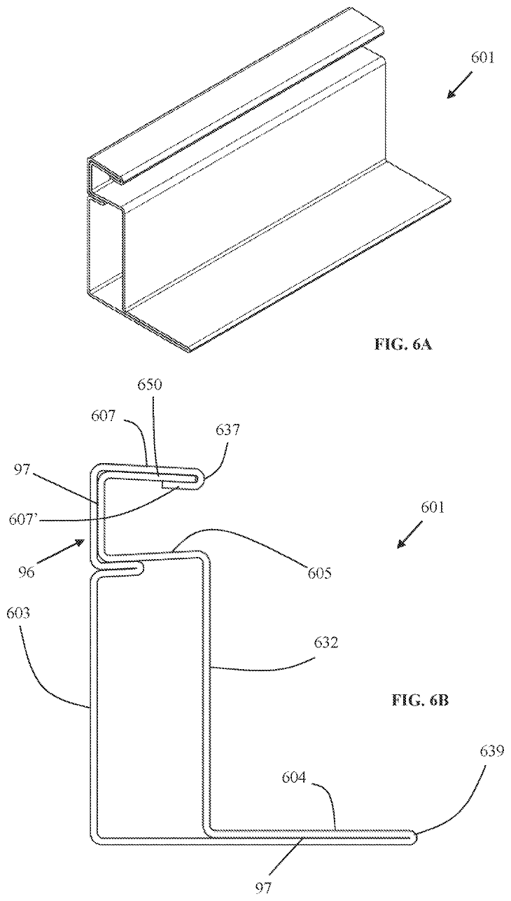

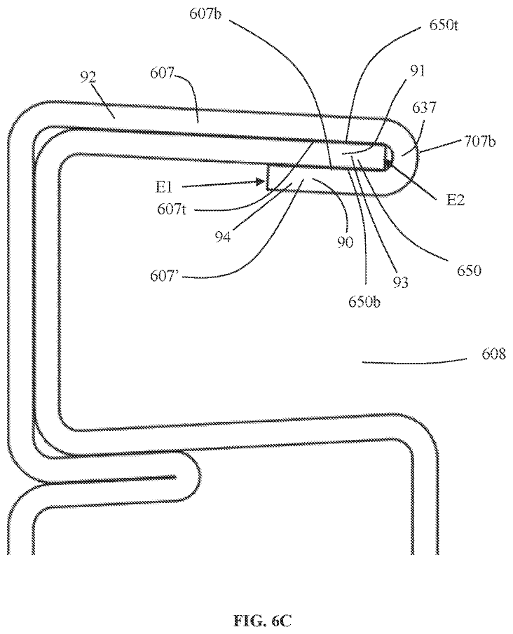

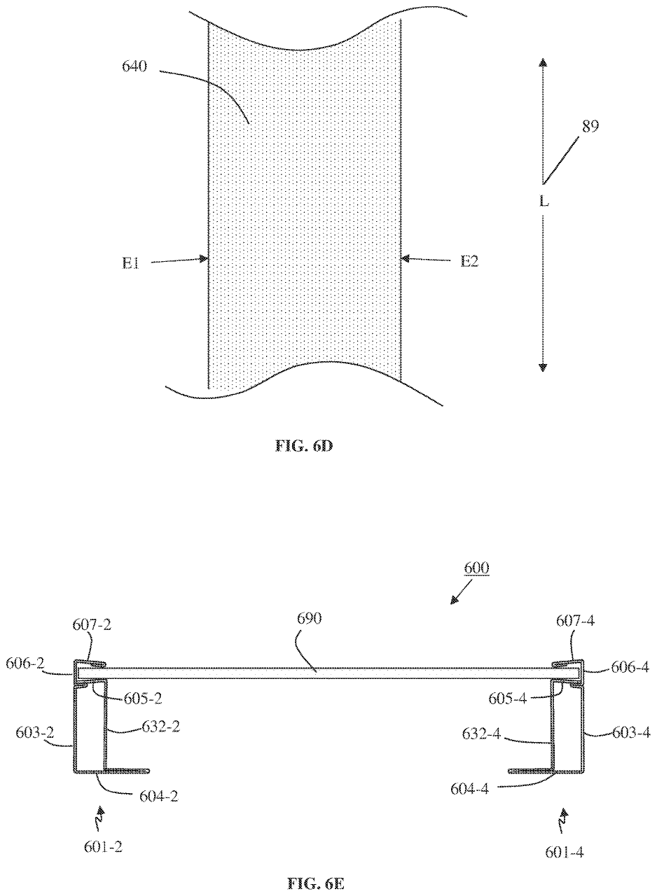

There are many embodiments of useful frame sections that include a support wall. FIG. 6A is a perspective view of a cutaway portion of a non-limiting example of a frame section including a support wall according to some embodiments. The height H and lengthwise L axes are also shown for reference. FIG. 6B is a cross-sectional view of the frame section from FIG. 6A, but labelled in a modified manner to clarify that any of the features may include an overlap 97 of framework providing two, three or more multiple layers of framework material which may provide an overlapped framework 96. Frame section 601 may include a framework material that has been cut and folded into a desired shape. Frame section 601 may include a bottom flange 604 provided at the base of the frame section, which in some embodiments may include multiple layers of framework material such as bottom flange layers 604′ and 604″. A frame sidewall 603 may be provided at an outer portion of the frame section and characterized by a height extending from the bottom flange. In some embodiments, a lengthwise fold 602 may define an intersection of the frame sidewall 603 and the bottom flange 604, e.g., with bottom flange layer 604′. A panel containment structure may be provided at an upper portion of the frame sidewall. The panel containment structure may include at least a lower shelf 605, and may also include a pocket wall 606, a top lip 607, and perhaps even a pocket region 608 for containing the panel. In some embodiments, some or all of the lower shelf 605 may include multiple layers of framework material, such as lower shelf layers 605′, 605″, 605′″. In some embodiments, two or more lower shelf layers may be formed from a fold in the framework material at the upper portion of the frame sidewall. In some embodiments, the top lip may be formed of multiple layers of framework material, such as top lip layer 607′ and top lip layer 607″ which may be formed from a top lip fold 637 to form a multilayered rounded top lip edge. A support wall 632 may be provided at an inner portion of the frame section (inner relative to the frame sidewall). In some embodiments, the support wall 632 may extend between the bottom flange and the lower shelf. In some embodiments, the frame section may include a reversing flange fold 639 such that a portion 604′ of the bottom flange may include a double layer of framework material. In some embodiments, another lengthwise fold 631 may define an intersection of the support wall 632 with the bottom flange structure, e.g., with portion 604′. In some cases, a lengthwise fold 633 may define an intersection of the support wall with the lower shelf 605.

FIG. 6D is a plan view of a non-limiting example of a portion of an elongated piece of framework material 640 prior to any cutting, punching, or folding operations used to make the frame section 601. The lengthwise dimension 98 of the framework material is illustrated as are a first edge E1 of a first end 90 and second edge E2 of a second end 91, which are also labelled in FIGS. 6A and 6B. In some embodiments, such as shown in FIGS. 6A and 6B, E1 may correspond to the end of top lip layer 607″ and E2 may correspond to the end of lower shelf layer 605′. In embodiments, an overlap 97 of at least part of an elongated piece of framework may include an overlap of a first end 90 with a second end 91 of framework material as shown in FIG. 6C. A first end 90 may have a bend 707b around a second end 91. This may provide an upper layer 92 of a first end, an inner layer 93 of the second end, and a bottom layer 94 of the wrapped first end of framework.

FIG. 6E is a cross-sectional view of a non-limiting example of a framed panel structure according to some embodiments. Framed panel structure 600 may include various frame sections as previously discussed, e.g., frame section 601-2 and opposing frame section 601-4 In some embodiments, each frame section may include a frame sidewall 603-2, 603-4, a bottom flange 604-2, 604-4, a lower shelf 605-2, 605-4, a pocket wall 606-2, 606-4, a top lip 607-2, 607-4, and a support wall 632-2, 632-4. The panel 690 may be received into a portion of each pocket region (formed by the lower shelf, the pocket wall, and the top lip) and secured in place, optionally with a sealant that may have adhesive properties (not shown). The frame sidewall of a frame section may be characterized as provided at an outer portion of the frame section whereas the support wall of the same frame section may be characterized as provided at an inner portion of the frame section. By “outer portion”, in some embodiments it is meant that, relative to the support wall position, the frame sidewall may be generally provided further from the center of the panel. By “inner portion”, in some embodiments it is meant that, relative to the frame sidewall position, the support wall may be generally provided closer to the center of the panel. That is, “outer portion” and “inner portion” are relative terms with respect to the frame sidewall and support wall, and do not necessarily mean the outermost part or innermost part of a frame section (although that may be the case in some embodiments).

Frames or frame precursor structures having a frame section like FIG. 6A or 6B may sometimes be referred to herein as a “box frame” where the bottom flange, frame sidewall, lower shelf and support wall collectively form in cross-section an enclosed structure, in this case, one having four sides. However, the term “box frame” may apply to any frame section that in cross section forms any enclosed shape. In some embodiments, the enclosed shape may involve at least the bottom flange, the frame sidewall, and the support wall, and have three or more apparent sides in cross section.

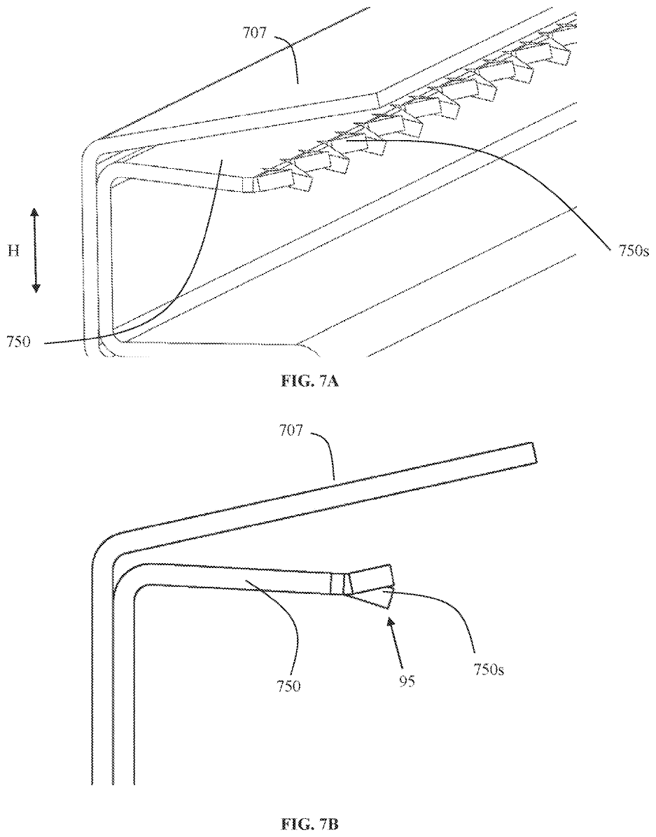

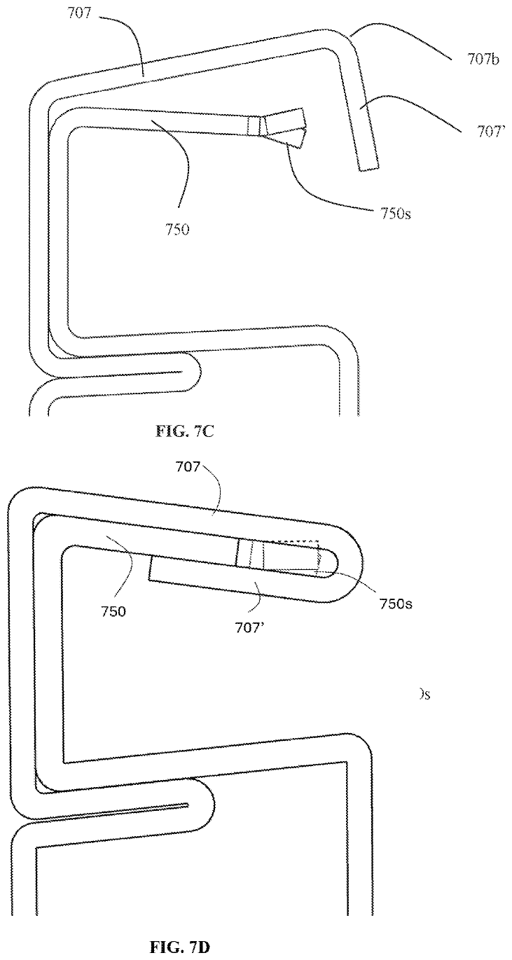

In some embodiments, it may be beneficial to secure overlapped framework perhaps via lock, fasten, adhere, stick, bond, or the like the layers of a frame together. In some instances, a frame pocket may refer to features 605, 607′, 637, 650, and 607 shown in FIG. 6B. Hereby, “locking” may be synonymous with fasten, adhere, stick, or bond. In some embodiments, locking the frame pocket may serve to increase the overall stiffness of the frame section in both a vertical direction as denoted by axis H of FIG. 7A and/or in a torsional direction parallel to the length of said frame section. A securement 95 may include but is not limited to teeth, dimples, tabs and holes, adhesives, gripping surfaces, or the like.

FIG. 7A is a perspective view of a portion of a non-limiting example of a frame section with teeth 750s formed in the inside layer 750. Teeth 750s may be sharp and may be located at a first end, a second end, along a side edge, or the like. Teeth can frictionally engage with and even embed into overlapped framework. Teeth 750s may be bent, non-bent, bent up, bent down, any permutation or combination thereof, or the like. Teeth may provide securement by embedding in an upper layer and even a bottom layer of a framework.

The vertical H axis is also shown for reference. FIG. 7B is a side view of the frame section from FIG. 7A with sharp, bent teeth 750s. Both FIGS. 7A and 7B may be considered precursors to FIGS. 7C and 7D. FIG. 7C shows the same side view as FIG. 7B at some point further along the folding process. FIG. 7D shows the same side view as FIG. 7C at the final point in the folding process. In all FIGS. 7A-D, frame section 750s may have sharp, bent teeth formed by a multitude of manufacturing processes including, but not limited to, punching, shearing, cutting, or forming. In some embodiments, the frame section teeth 750s may be bent up or down relative to vertical axis H. Any number of bent teeth may be up or down, and may alternate directions in any number of sequences, with non-limiting examples including one up, one down; one up, two down; two up, one down. The teeth 750s may be bent at any number of angles, including, but not limited to between about 0° to 90°, about 5°, about 10°, about 15°, less than about 90° or any other angle. In some embodiments, the teeth 750s may not be bent and may be on-plane with layer 750.

FIG. 7C shows the frame section where the top layer 707 has been partially bent to begin the fold under the middle layer. In some embodiments, the bend 707b may be an angle near 90°, but may also be any angle between about 0 to about 180°. This bend 707b angle is 0° in precursor stages such as shown in FIGS. 7B and 180° in successor stages such as shown in FIG. 7D. This bent portion 707′ may eventually be folded under the inner layer 750, with a non-limiting example shown in FIG. 7D. At some point in time between FIGS. 7C and 7D, the sharp teeth 750s may embed themselves into layers 707 and 707′ in order to lock the layers 707 and 707′ to middle layer 750.

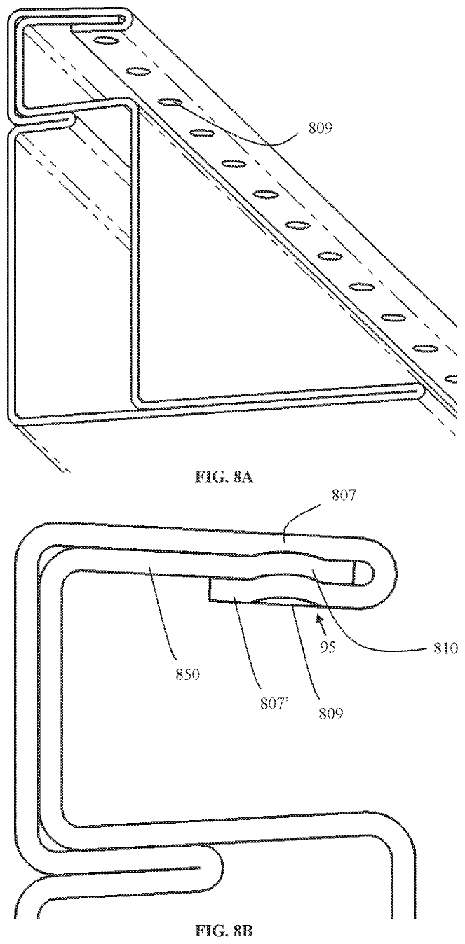

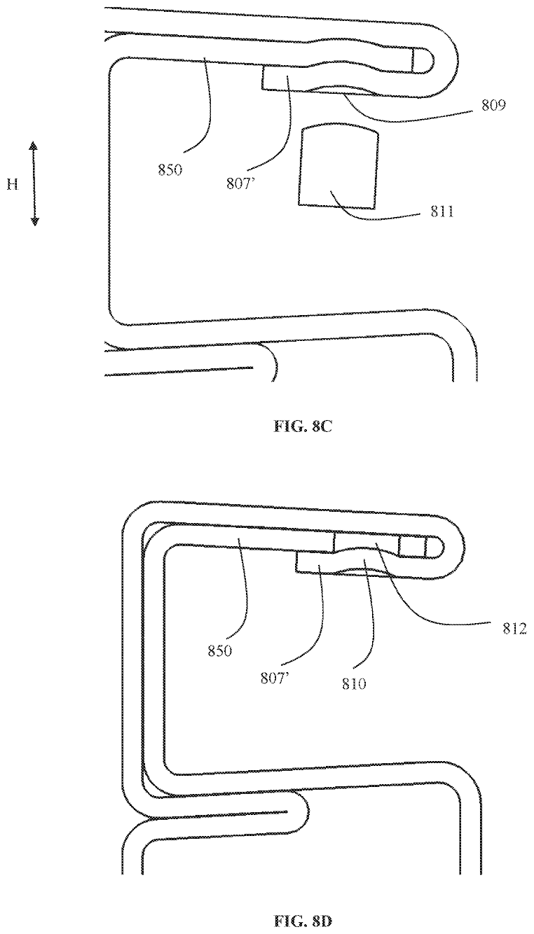

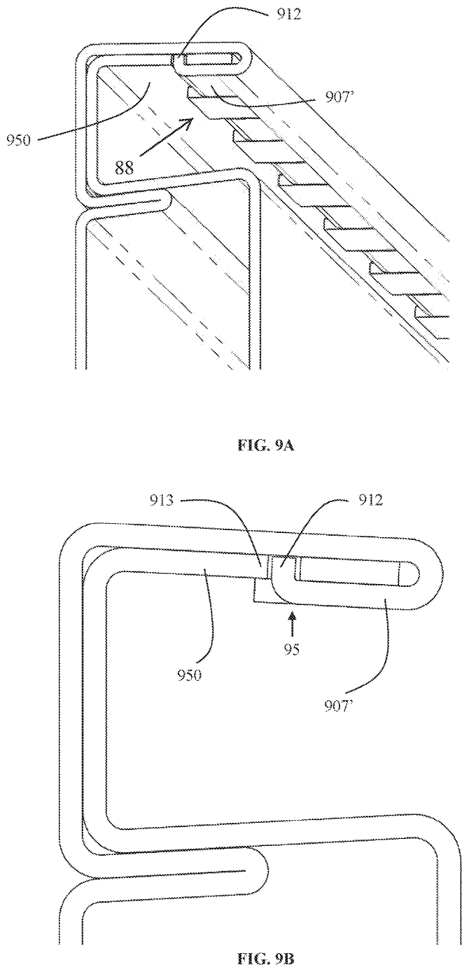

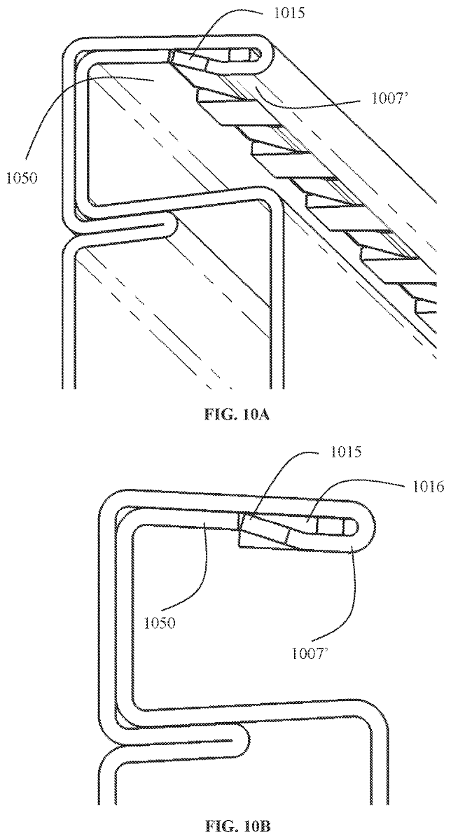

In some embodiments, another securement may be a dimple feature 809 as shown in FIGS. SA-D. A dimple may be formed in any layer of overlapped framework such as in the inner layer, bottom layer, upper layer, more than one layer, or the like. FIG. 8A shows a perspective view of a multitude of these dimple features 809. This non-limiting example shows the dimples 809 formed into the bottom layer 807′. Any number of dimples 809 may be used for a representative frame section. These dimples 809 serve to lock the inner layer 850 in between layers 807 and 807′. FIG. 8B shows a side view of the same, non-limiting example shown in FIG. 8A. The dimple(s) in layer 807′ may be pressed into the material by any multitube of tools. Upon creation, the dimple(s) 809 may press into inner layer 850 and create additional dimple(s) 810. A nesting dimple(s) 809 and 810 may be formed and may serve to lock layers 807, 850, and 807′ together. In some embodiments, dimple(s) 810 may partially indent the upper layer 807. A non-limiting example of a dimple forming tool 811 is shown in FIG. 8C. In some embodiments, the dimple forming tool 811 may be cylindrical-shaped, but it may also take any number of other shapes, such as, but not limited to, a disc, oval, or sphere. As such, a dimple may be shaped cylindrical, disc, oval, sphere, or the like. The tool 811 may travel up and down in the direction of vertical axis H. FIG. 8D shows a non-limiting example of a case where the inner layer dimple 810 is replaced with a hole 812. As such, a dimple may be formed in one layer and a hold may be formed in a corresponding layer so that the dimple may lock into the hole when overlapped. Hole 812 may be formed prior to any frame bending or may be formed during any stage of the folding process prior to layer 807′ contacting the lower side of layer 850. In some embodiments, dimple 810 may protrude into hole 812 to lock layers 850 and 807′ together.

Yet another possible locking mechanism is shown in FIGS. 9A and 9B. FIG. 9A is a perspective view of a multitude of securements, while FIG. 9B is a side view of said securements. A securement may be a tab lock 88 utilizing a tab and a hole. In some embodiments, inner layer 950 may have one or more holes 913 through the entirety of the material. The lower layer 907′ may have tabs or flanges 912 bent at approximately 90°, less than about 90°, more than about 90°, or the like with respect to the lower layer 907′. These tabs 912 may be bent prior to layer 907′ contacting layer 950 (similar to the bending stage shown in FIG. 7C). In some embodiments, tabs 912 may insert into holes 913 in order to lock layers 950 and 907′ together. There are any number of possible pairings for holes 913 and tabs 912. Non-limiting examples may include one tab 912 for every one hole 913, two tabs 912 for every one hole 913, or any other combination. Holes 913 may be sized such that tabs 912 have an interference fit with holes 913, or they may be sized such that tabs 912 have a clearance fit with holes 913.

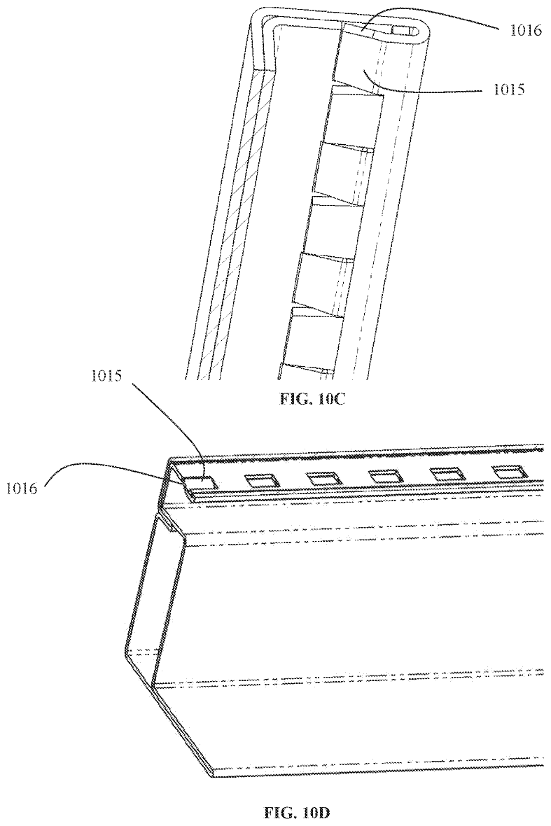

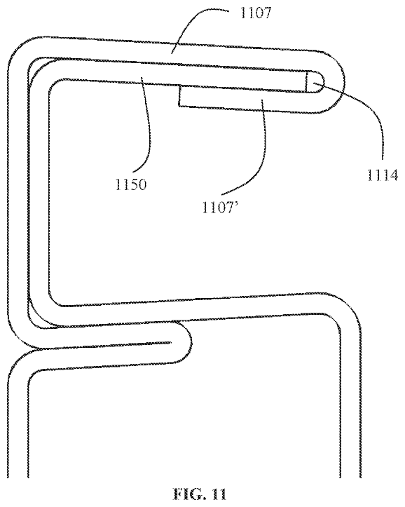

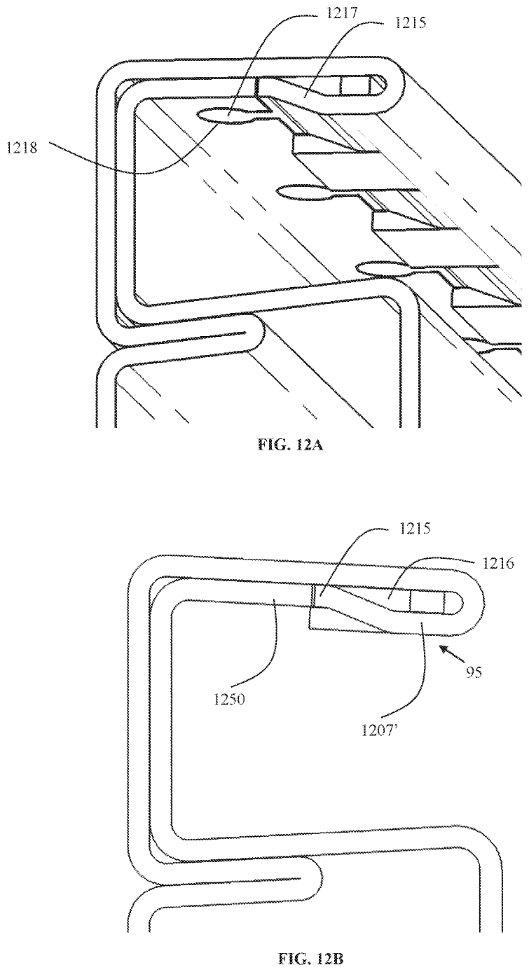

Another possible locking mechanism is shown in FIGS. 10A and 10B. FIG. 10A is a perspective view of a pattern of locking mechanisms, while FIG. 10B is a side view of said locking mechanisms. In some embodiments, inner layer 1050 may have one or more boles 1016 through the entirety of the material. The lower layer 1007′ may have tabs or flanges 1015 bent at an acute angle with respect to the lower layer 1007′. These tabs 1015 may be bent prior to layer 1007′ contacting layer 1050 (similar to the bending stage shown in FIG. 7C). In some embodiments, tabs 1015 may insert into holes 1016 in order to lock layers 1050 and 1007′ together. There are any number of possible pairings for holes 1016 and tabs 1015. Non-limiting examples may include one tab 1015 for every one hole 1016, two tabs 1015 for every one hole 1016, or any other combination. Holes 1016 may be sized such that tabs 1015 have an interference fit with holes 1016, or they may be sized such that tabs 1015 have a clearance fit with holes 1016. In some embodiments, tabs 1015 may have sloped or angled sides 1017 such that the tabs 1015 serve to align layer 1007′ with respect to layer 1050.

FIG. 11 shows a non-limiting example of a side view of a frame section. In some embodiments, frame layers 1107, 1150, and 1107′ may be locked together using an adhesive as a securement. Adhesive may be placed between layers 1107 and 1150, and between layers 1150 and 1107′. Adhesive may be placed in a bend of a first end folded around a side edge of a second end or in between an upper, lower, and inner layer or the like. In some embodiments, the adhesive may fill gap 1114. Any number of adhesives may be used, including, but not limited to, silicones, two-part epoxies, or glues. The adhesive may be applied at any point during the forming process prior to layer 1107′ contacting layer 1150.

FIGS. 12A-C show a non-limiting variation of the frame section depicted in FIGS. 10A-C. In some embodiments, inner layer 1250 may have one or more holes 1216 through the entirety of the material. The lower layer 1207′ may have tabs or flanges 1215 bent at an acute angle with respect to the lower layer 1207′. These tabs 1215 may be bent prior to layer 1207′ contacting layer 1250 (similar to the bending stage shown in FIG. 7C). In some embodiments, tabs 1215 may insert into holes 1216 in order to lock layers 1250 and 1207′ together. There are any number of possible pairings for holes 1216 and tabs 1215. Non-limiting examples may include one tab 1215 for every one hole 1216, two tabs 1215 for every one hole 1216, or any other combination. Holes 1216 may be sized such that tabs 1215 have an interference fit with holes 1216, or they may be sized such that tabs 1215 have a clearance fit with holes 1216. In some embodiments, tabs 1215 may have an extension 1217 which fits into an extension 1218 of hole 1216. These extensions 1217 and 1218 serve to more securely fasten tabs 1215 into holes 1216. FIG. 12C shows a non-limiting cross section of a frame section that includes features 1215, 1216, 1217, and 1218.

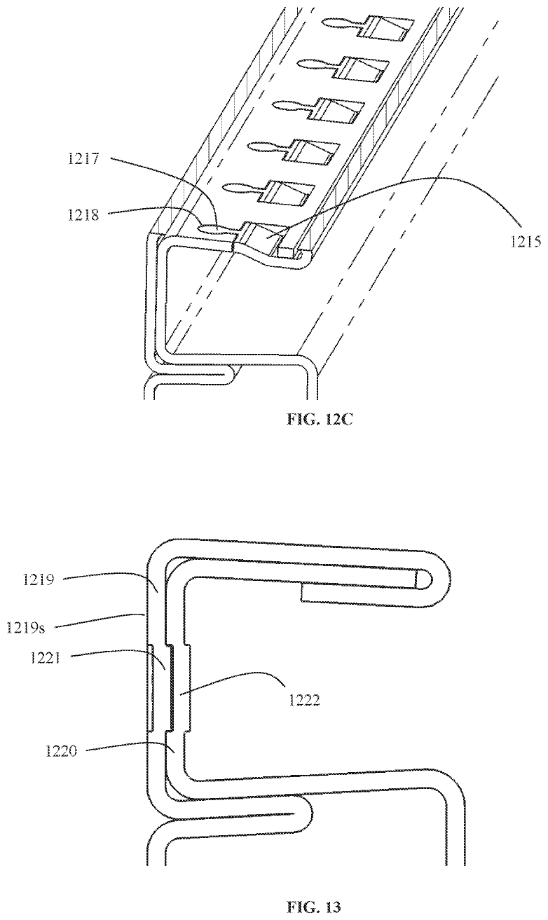

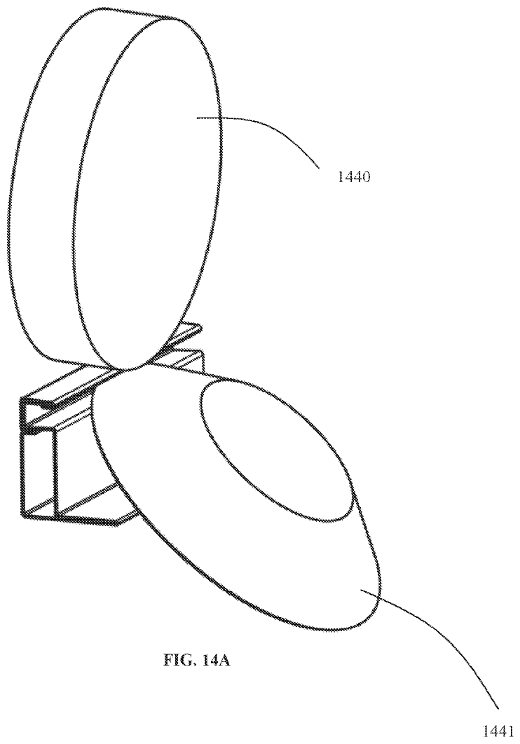

Another non-limiting example of a locking mechanism is shown in FIG. 13, which is a side view of a representative frame section. In some embodiments, a representative frame section may have an outer back wall 1219 and inner back wall 1220. It may be desirable for these layers to be locked together. One such way to lock layers 1219 and 1220 together may be to create a dimpled or clinched feature. Said feature has an outer dimple or clinch 1221 which nests inside inner dimple or clinch 1222. Clinches 1221 and 1222 may take any number of shapes including, but not limited to, circles, ovals, squares, or rectangles. In some embodiments, clinch 1221 may be recessed from surface 1219s in order to protrude into clinch 1222.

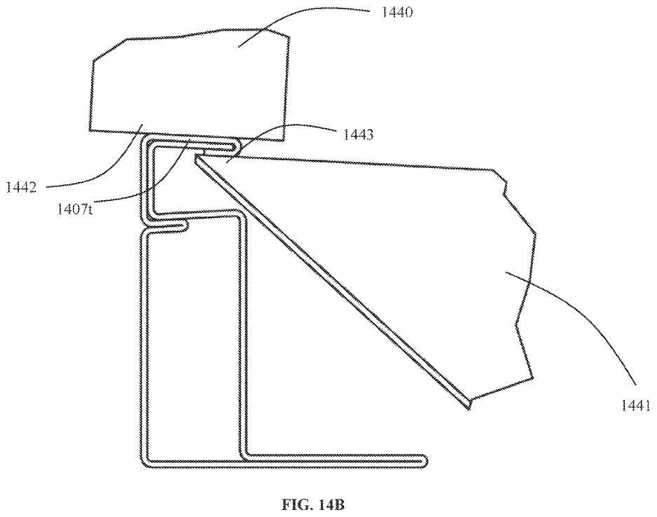

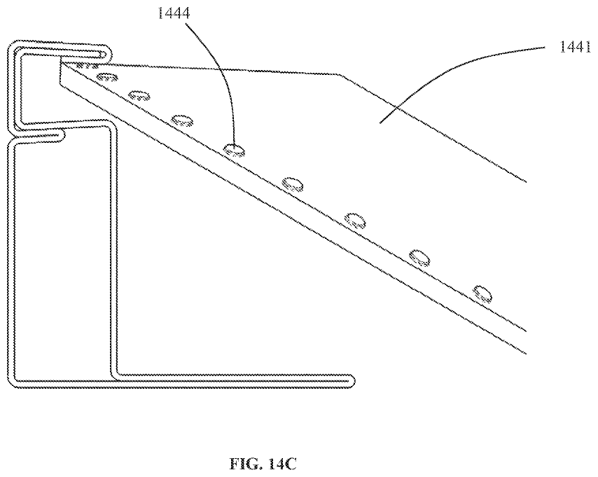

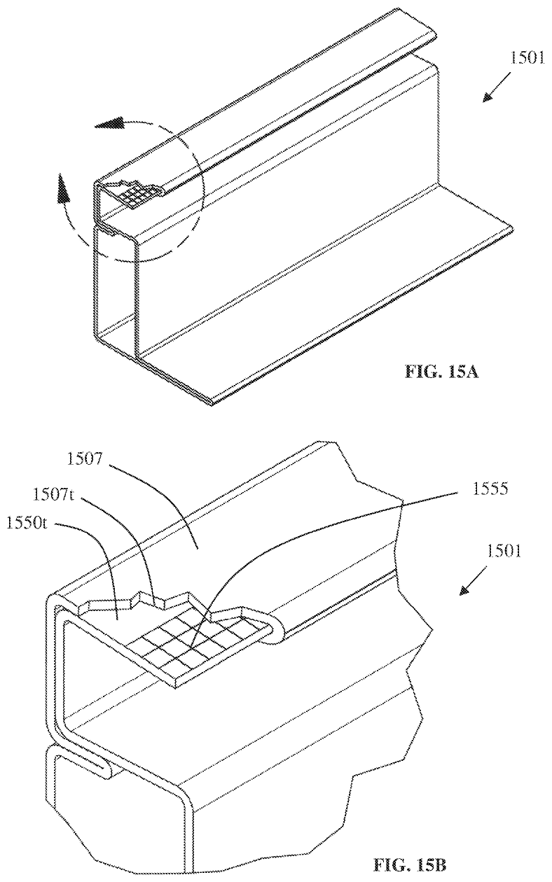

FIG. 14A shows a perspective view of a non-limiting example of two rollers that may be used to form any of the locking or frictional mechanisms detailed in FIGS. 7-13. In some embodiments, the two rollers may be described as an upper roller 1440 and lower roller 1441. FIG. 14B shows a side view of the same two rollers (1440 and 1441) and a representative frame section. In some embodiments, the rollers may work in conjunction to form one or several of the bends in the frame. The upper roller 1440 may have a surface 1442 that is in contact with the upper surface 1407t of the frame section. Surface 1442 may be perpendicular to the axis of rotation of roller 1440, or it may have some other inclination. Examples of possible inclination angles may include 5°, 10°, 15°, or any other angle less than 90°. In some embodiments, the lower roller 1441 may have a surface 1443 which contacts the lower surface of the folded-over frame section 1407. Roller 1441 may be shaped as such that it enables surface 1443 to fit into the frame opening as shown in FIG. 14B. Surface 1443 and surface 1442 together may be used to press, force, compress, or squeeze frame layers 1407 and 1450 together.

In some embodiments, roller 1441 may have features that imbibe the locking or frictional features described in FIGS. 7-13 into the frame sections 1407 and 1450. FIG. 14C shows a non-limiting example of the imbibing feature 1444. This imbibing feature may be raised or submerged from/into surface 1443. The imbibing feature 1444 may take form with a variety of shapes, including, but not limited to circle, square, rectangle, star, or other geometries. In some embodiments, the imbibing feature 1444 may create dimples in the frame section similar to those shown in FIGS. 8A and 8B.

In embodiments, a securement may be a grip surface 89 on part of a framework. A grip surface 89 may be a corrugated surface, a rough surface, a lacerated surface, a scored surface, hatched surface, double hatched surface, irregular hatching surface, or the like which can interface with an overlapped surface of framework. A grip surface may be located on one or both surfaces interfacing when overlapped. As a non-limiting example, a grip surface may be located on an inner layer surface, an inside layer top surface, an inside layer bottom surface or both said inside layer top and bottom surfaces, or the like.

The square hatch areas shown as locking features 1555 in FIGS. 15A-15I, locking feature 1655 in FIG. 16A and B, locking features 1755 in FIGS. 17A-E, represent locking features that will be further explained when discussing FIGS. 15L-Q, FIG. 16C, and FIGS. 17F-L.

Referring to FIGS. 6A-C, FIGS. 15A-D, and FIG. 16A and B, the section of the top lip layers 1507, 1507′, 1607 and 1607′ has been cut away to show the beneath layers and features.

In some embodiments, the locking features may be on the surfaces inside layer. As shown in FIGS, 15A, 15B, 15E and 15F, the locking features 1555 are shown on the inside layer top surface 1550t. As shown in FIGS, 16A and 16B, the locking features 1655 are shown on the inside layer bottom surface 1550b. The locking features may be on the inside layer top surface or the inside layer bottom surface or both top and bottom inside layer surfaces.

As shown in FIG. 15C and D, the inner grip surface edge 1557 extends beyond the edge E1. The outer grip surface edge 1556 extends to about the edge E2. As shown in FIG. 16A, the inner grip surface edge is shown inside the edge E1 and the outer grip surface edge 1655 is away from the end E2. The inner grip surface edge may also wander inside and outside the edge E1 and the outer grip surface edge may wander about at the edge E2 or away from the edge E2.

FIG. 15F shows the location of the top lip layer coupon 1558 and FIG. 16B shows the location of the top lip layer coupon 1655. To better show and discuss more details of the locking features 1555 and 1655, the area outside the location of the dashed lines will not be shown as shown in FIGS. 15G-Q and 16C.

FIGS. 15G-I show the locking features 1555 on the top lip layer coupon 1558. FIGS. 15J-O show more details on the locking features 1555. A grip surface may have protrusions and depressions perhaps so when overlapped the gripping surfaces can mate with each other. Referring to FIGS. 15J-O, the depressions 1560 may go below the inside layer top surface 1550t. The depressions 1560 may go below the inside layer top surface 1550b. The protrusions 1559 may go above the inside layer top surface 1550t. The protrusions 1559 may go above the inside layer top surface 1550b.

FIG. 15P and Q show a different example of locking features. Grip surfaces may be in many different patterns and two surfaces interfacing may have different grip surfaces on each. In FIGS. 15J-Q, the protrusions 1559 and depressions 1560 are shown as symmetrical on the inside layer surfaces, 1550t and 1550b but they may not be symmetrical. The depressions and protrusions shown are uniform and same height, depth and spacing but they could be any height, depth and spacing. They also could be non-continuous or random. The depressions and protrusions may be any shape, size or quantity as individual or as group. The inside layer surfaces could have only protrusions or depressions.

The top lip layer coupon 1658 location is shown on FIG. 15F. The top lip layer coupon 1658 may be similar to top lip layer coupon 1558. The top lip layer coupon 1658 may have a spacing t as shown.

In some embodiments, the locking features may be formed by patterned rollers in the roll forming line. FIGS. 17A-D show the strip sheet 1765 being compressed by two opposing pattern rollers 1763 with roller grip patterns 1764. This process may form locking features 1755 on both sides of the strip sheet. If only one side of locking features were needed, then one of the rollers would not be patterned.

The direction strip sheet and rotation direction of the rollers are shown on FIG. 17A and C. The strip sheet 1765 shows a short length in FIGS. 17A-D but it may normally be a long strip from a coil and may be continuously fed through the roll forming equipment. The forming of the locking features 1755 is shown when the strip sheet 1765 is flat. This forming may take place after folds are made.

The dotted circle on FIG. 17E is the location of the views for FIGS. 17F-L. FIGS. 17F-L show different patterns for the locking features 1755. FIG. 17F may be the pattern for the locking features 1755 used for FIG. 16C. As mentioned earlier, FIG. 16C is similar to FIGS. 15J-M.

FIGS. 17F-K are single hatch or double hatched. More than 2 hatches could be made but are not shown. FIG. 17L shows that irregular hatching may be possible.

Referring to FIG. 6C, when the top lip layer 607 formed around edge E2 and into the position as shown in top lip layer 607′, For the locking features to be effective, a high force needs to be applied between top lip layer 607 and top lip layer 607′. As such, a high force applicator nay be used to force layers together that have any type of securement such as grip surfaces, dimples, tab locks, teeth, or the like. This high force applicator applying high force to the framework layers can deform the overlapped framework forced against a securement. As a non-limiting example, when two overlapped layers of framework have one layer with teeth, when the layers are forced together, the second layer can be deformed by the teeth in the first layer.

The depression bottom 1562 and the protrusion top 1561 in FIG. 1SM shows sharp corners. The depression bottom 1562 may not be sharp corner due to roller grip pattern radii and wear on the grip pattern. The protrusion top 1561 on roller grip pattern may have a radius and the flow of the steel into the cavity may not be complete. The radii is shown in FIG. 15N and O.

This force may also be applied as shown in FIGS. ISA-C. The frame section 1801 is shown in FIG. 18A. In the roll forming, this would be a frame that would be continuously fed through the roll form equipment. After the high force is applied, the top lip could then be bent down with rollers to the final position shown in FIG. 6B and C.

Referring to FIGS. 6B, 6C, and 15M. This applied force may drive the protrusions 1599 on the inside layer surfaces 650t and 650b into the top lip surfaces 607t and 607b. It may also force the lip layer surfaces 607t and 607b into the inside layer depressions 1560 into 650t and 650b surfaces. This may make a very strong connection between layers which may greatly increase the frame torsion resistance.

Referring to FIGS. 6B and C, the edges D1 and D2 are in close proximity with each other on the top lip layer in the pocket region, 608. Other roll join edge areas could be used such as but not limited to the any location on the frame sidewall 603, support wall 632, bottom flange 604, and the flange fold area 619. The use of the locking features can benefit all these areas for frame twist reduction.

While the application has been described in connection with some embodiments, it is not intended to limit the scope to the particular form set forth, but on the contrary, it is intended to cover such alternatives, modifications, and equivalents as may be included within the spirit and scope of the application. Examples of alternative claims may include:
1. A frame for at least partially enclosing or supporting a solar panel comprising:
an elongated piece of framework material having a first end and a second end, said first and second end defining lengthwise dimension,
wherein said elongated piece of framework material is folded along said lengthwise dimension to form a folded framework having a panel containment structure configured to support part of a solar panel;
wherein said folded framework comprises an overlap of at least part of said elongated piece of framework creating an overlapped framework; and
a securement configured to secure said overlapped framework.
2. The frame as described in clause 1 or any other clause wherein said folded framework comprises a bottom flange and a frame sidewall.
3. The frame as described in clause 1 or any other clause wherein said panel containment structure comprises a lower shelf, a pocket wall, a top lip, and a pocket region.
4. The frame as described in clause 3 or any other clause wherein said pocket region comprises said overlapped framework and wherein said securement is located between overlapped framework in said pocket region.
5. The frame as described in clause 1 or any other clause wherein said overlap of said at least part of said elongated piece of framework comprises an overlap of said first end with said second end of said elongated piece of framework material.
6. The frame as described in clause 5 or any other clause wherein said overlap of said first end with said second end of said at least part of said elongated piece of framework comprises a bend in said first end folded around a side edge of said second end.
7. The frame as described in clause 6 or any other clause and further comprising an upper layer of said first end of said framework, an inner layer of said second end of said framework, and a bottom layer of said wrapped first end of said framework.
8. The frame as described in clause 6 or any other clause wherein said bend comprises an angle selected from about 90 degrees and between about 0 degrees and about 180 degrees.
9. The frame as described in clause 1 or any other clause wherein said securement comprises teeth at one of said first or second ends configured to frictionally engage with said overlapped framework.
10. The frame as described in clause 9 or any other clause wherein said teeth are selected from bent teeth; non-bent teeth; bent up teeth; bent down teeth; and any permutation or combination thereof.
11. The frame as described in clause 10 or any other clause wherein said bent teeth are bent at an angle selected from between about 0 degrees and about 90 degrees; about 5 degrees; about 10 degrees; about 15 degrees; and less than about 90 degrees.
12. The frame as described in clause 6 or any other clause and further comprising teeth at said side edge of said second end configured to embed into said overlapped framework.
13. The frame as described in clause 7 or any other clause and further comprising teeth at said side edge of said second end configured to embed into said upper layer and said bottom layer of said framework.
14. The frame as described in clause 9 or any other clause wherein said teeth are formed by a manufacturing process selected from punching, shearing, cutting, and forming.
15. The frame as described in clause 9 or any other clause and further comprising a high force applicator configured to force said teeth into said overlapped framework.
16. The frame as described in clause 15 or any other clause wherein said high force applicator configured is to deform said overlapped framework with said teeth.
17. The frame as described in clause 1 or any other clause wherein said securement comprises a dimple feature in said overlapped framework.
18. The frame as described in clause 17 or any other clause wherein said dimple feature comprises a dimple formed in an inner layer of said overlapped framework, wherein said dimple is configured to lock said inner layer with an overlapped layer of framework.
19. The frame as described in clause 17 or any other clause wherein said dimple feature comprises a nesting dimple in each layer of said overlapped framework.
20. The frame as described in clause 17 or any other clause wherein said dimple feature comprises a shape selected from cylindrical, disc, oval, and sphere.
21. The frame as described in clause 17 or any other clause wherein said dimple feature comprises a dimple in one layer of said overlapped framework and a hole in the corresponding layer of said overlapped framework so that said dimple locks in said hole when overlapped.
22. The frame as described in clause 7 or any other clause and further comprising a dimple feature in said upper layer, said inner layer, and said bottom layer of said overlapped framework.
23 The frame as described in clause 7 or any other clause and further comprising a dimple in said bottom layer.
24. The frame as described in clause 23 or any other clause and further comprising a dimple in said inner layer configured to nest with said dimple in said bottom layer.
25. The frame as described in clause 23 or any other clause and further comprising a hole in said inner layer configured to lock said dimple of said bottom layer in said hole of said inner layer.
26. The frame as described in clause 17 or any other clause wherein said dimple feature is formed with a dimple forming tool.
27. The frame as described in clause 4 or any other clause and further comprising a dimple feature in an overlapped framework of said pocket region.
28. The frame as described in clause 17 or any other clause wherein said overlapped framework comprises a plurality of dimple features.
29. The frame as described in clause 17 or any other clause and further comprising a high force applicator configured to force said dimple into said overlapped framework.
30. The frame as described in clause 29 or any other clause wherein said high force applicator is configured to deform said overlapped framework with said dimple.
31. The frame as described in clause 1 or any other clause wherein said securement comprises a tab lock.
32. The frame as described in clause 31 or any other clause wherein said tab lock comprises a hole in one of said overlapping layers and a tab in the other of said overlapping layers wherein said tab configured to lock into said hole.
33. The frame as described in clause 32 or any other clause wherein said tab lock comprises at least two tabs for each hole.
34. The frame as described in clause 32 or any other clause wherein said tabs comprise a bent tab at an angle selected from about 90 degrees, less than about 90 degrees, and more than about 90 degrees.
35. The frame as described in clause 32 or any other clause wherein said tabs comprise an interference fit with said hole.
36. The frame as described in clause 32 or any other clause wherein said tabs comprise a clearance fit with said hole.

37. The frame as described in clause 31 or any other clause wherein said overlapped framework comprises a plurality of tab locks.
38. The frame as described in clause 31 or any other clause and further comprising a high force applicator configured to force together said tab lock between said overlapped framework.
39. The frame as described in clause 32 or any other clause wherein said hole comprises an extension to said hole and wherein said tab comprises an extension to said tab.
40. The frame as described in clause 39 or any other clause wherein said extension to said tab is configured to lock into said extension of said hole.
41. The frame as described in clause 1 or any other clause wherein said securement comprises an adhesive between said overlapped framework.
42. The frame as described in clause 6 or any other clause wherein said securement comprises an adhesive in said bend in said first end folded around said side edge of said second end.
43. The frame as described in clause 7 or any other clause wherein said securement comprises an adhesive between said upper layer, said lower, and said inner layer of said overlapped framework.
44. The frame as described in clause 41 or any other clause wherein said adhesive is selected from silicone, epoxy, two-part epoxies, and glue.
45. The frame as described in claim 1 or any other clause wherein said securement is created in said framework with at least one roller applied to said framework.
46. The frame as described in clause 45 or any other clause wherein said at least one roller comprises an upper roller and a lower roller wherein said upper roller is configured to contact an upper surface of said overlapped framework and said lower roller is configured to contact a lower surface of said overlapped framework.
47. The frame as described in clause 45 or any other clause wherein said at least one roller is configured to imbibe said securement on said framework.
48. The frame as described in clause 1 or any other clause wherein said securement comprises a grip surface on part of said framework.
49. The frame as described in clause 48 or any other clause wherein said grip surface is selected from a corrugated surface, a rough surface, a lacerated surface, a scored surface, hatched surface, double hatched surface, and irregular hatching surface.
50. The frame as described in clause 48 or any other clause wherein said grip surface is located on one surface in between said overlapped framework.
51. The frame as described in clause 48 or any other clause wherein said grip surface is located on both surfaces in between said overlapped framework.
52. The frame as described in clause 7 or any other clause and further comprising a grip surface located on said inner layer surface selected from an inside layer top surface, an inside layer bottom surface or both said inside layer top and bottom surfaces.
53. The frame as described in clause 48 or any other clause wherein said grip surface comprises protrusions and depressions.
54. The frame as described in clause 48 or any other clause wherein both surfaces of an overlapped framework comprise said grip surface and when overlapped said grip surfaces mate with each other.
55. The frame as described in clause 51 or any other clause wherein said grip surface on one of said surfaces is different than a grip surface on the overlapping surface.
56. The frame as described in clause 51 or any other clause and further comprising a high force applicator configured to force said grip surface layers together.
57. The frame as described in clause 56 or any other clause wherein said high force applicator is configured to deform said overlapped framework with said grip surface.
58. A method for forming a frame to at least partially enclose or support a solar panel comprising steps of:
providing an elongated piece of framework material having a first end and a second end, said first and second end defining a lengthwise dimension;
folding said elongated piece of framework along said lengthwise dimension;
creating a panel containment structure with said folded framework;
overlapping at least some of said elongated piece of framework to create an overlapped framework; and
securing at least part of said overlapped framework.
59. The method as described in clause 58 or any other clause wherein said step of creating said panel containment structure comprises a step of providing a lower shelf, a pocket wall, a top lip, and a pocket region of said panel containment structure.
60. The method as described in clause 59 or any other clause wherein said step of securing at least part of said overlapped framework comprising a step of securing overlapped framework in said pocket region.
61. The method as described in clause 58 or any other clause and further comprising a step of overlapping said first end on said second end of said elongated piece of framework material.
62. The method as described in clause 61 or any other clause wherein said step of overlapping said first end on said second end of said elongated piece of framework material comprises providing a bend in said first end folded around a side edge of said second end.
63. The method as described in clause 62 or any other clause and further comprising a step of providing an upper layer of said first end of said framework, an inner layer of said second end of said framework, and a bottom layer of said wrapped first end of said framework.
64. The method as described in clause 62 or any other clause wherein said bend comprises an angle selected from about 90 degrees and between about 0 degrees and about 180 degrees.
65. The method as described in clause 58 or any other clause wherein said step of securing at least part of said overlapped framework comprises steps of:
providing teeth at one of said first or second ends; and
frictionally engaging said teeth with said overlapped framework.
66. The method as described in clause 65 or any other clause wherein said teeth are selected from bent teeth; non-bent teeth; bent up teeth; bent down teeth; and any permutation or combination thereof.
67. The method as described in clause 66 or any other clause wherein said bent teeth are bent at an angle selected from between about 0 degrees and about 90 degrees; about 5 degrees; about 10 degrees; about 15 degrees; and less than about 90 degrees.
68. The method as described in clause 62 or any other clause and further comprising steps of:
providing teeth at said side edge of said second end; and
embedding said teeth into said overlapped framework.
69. The method as described in clause 63 or any other clause and further comprising steps of:
providing teeth at said side edge of said second end; and
embedding said teeth into said upper layer and said bottom layer of said framework.
70. The method as described in clause 65 or any other clause and further comprising a step of forming said teeth by a manufacturing process selected from punching, shearing, cutting, and forming.
71. The method as described in clause 65 or any other clause and further comprising a step of applying a high force to said overlapped framework having said teeth.
72. The method as described in clause 71 or any other clause and further comprising a step of deforming said overlapped framework with said teeth.
73. The method as described in clause 58 or any other clause wherein said step of securing at least part of said overlapped framework comprises a step of securing at least part of said overlapped framework with a dimple feature.
74. The method as described in clause 73 or any other clause wherein said step of securing with said dimple feature comprises steps of:
forming a dimple in an inner layer of said overlapped framework; and
locking said inner layer with an overlapped layer of framework.
75. The method as described in clause 73 or any other clause and further comprising a step of nesting a dimple in each layer of said overlapped framework.
76. The method as described in clause 73 or any other clause and further comprising a step of providing a shape of said dimple feature selected from cylindrical, disc, oval, and sphere.
77. The method as described in clause 73 or any other clause wherein said step of securing at least part of said overlapped framework with said dimple feature comprises steps of:
forming a dimple in one layer of said overlapped framework,
providing a hole in a corresponding layer of said overlapped framework; and
locking said dimple locks in said hole when overlapped.
78. The method as described in clause 63 or any other clause and further comprising a step of forming a dimple feature in said upper layer, said inner layer, and said bottom layer of said overlapped framework.
79. The method as described in clause 63 or any other clause and further comprising a step of forming a dimple in said bottom layer.
80. The method as described in clause 79 or any other clause and further comprising steps of forming a dimple in said inner layer; and nesting with said dimple in said bottom layer.
81. The method as described in clause 79 or any other clause and further comprising steps of providing a hole in said inner layer; and locking said dimple of said bottom layer in said hole of said inner layer.
82. The method as described in clause 73 or any other clause and further comprising a step of forming said dimple feature with a dimple forming tool.
83. The method as described in clause 60 or any other clause and further comprising a step of providing a dimple feature in an overlapped framework of said pocket region.
84. The method as described in clause 73 or any other clause wherein said step of securing at least part of said overlapped framework with said dimple feature comprises securing at least part of said overlapped framework with a plurality of dimple features.
85. The method as described in clause 73 or any other clause and further comprising steps of applying a high force to said dimple feature and forcing said dimple into said overlapped framework.
86. The method as described in clause 85 or any other clause and further comprising a step of deforming said overlapped framework with said dimple.
87. The method as described in clause 58 or any other clause wherein said step of securing at least part of said overlapped framework comprises a step of providing a tab lock in an overlapped framework.
88. The method as described in clause 87 or any other clause wherein said step of providing said tab lock comprises steps of:
providing a hole in one of said overlapping layers and a tab in the other of said overlapping layers; and
locking said tab into said hole when said layers are overlapped.
89. The method as described in clause 88 or any other clause and further comprising a step of locking at least two tabs in said hole.
90. The method as described in clause 88 or any other clause and further comprising a step of bending said tab at an angle selected from about 90 degrees, less than about 90 degrees, and more than about 90 degrees.
91. The method as described in clause 87 or any other clause wherein said step of providing a tab lock in an overlapped framework comprises a step of providing a plurality of said tab locks in said overlapped framework.
92. The method as described in clause 87 or any other clause further comprising a step of applying a high force to said tab lock between said overlapped framework.
93. The method as described in clause 87 or any other clause and further comprising a step of deforming at least part of said tab with said high force.
94. The method as described in clause 88 or any other clause wherein said hole comprises an extension to said hole and wherein said tab comprises an extension to said tab.
95. The method as described in clause 94 or any other clause and further comprising a step of locking said extension to said tab into said extension of said hole.
96. The method as described in clause 58 or any other clause wherein said step of securing at least part of said overlapped framework comprises a step of securing at least part of said overlapped framework with an adhesive.
97. The method as described in clause 62 or any other clause and further comprising a step of applying an adhesive in said bend in said first end folded around said side edge of said second end.
98. The method as described in clause 63 or any other clause and further comprising a step of applying an adhesive between said upper layer, said lower, and said inner layer of said overlapped framework.
99. The method as described in clause 96 or any other clause wherein said adhesive is selected from silicone, epoxy, two-part epoxies, and glue.
100. The method as described in clause 58 or any other clause and further comprising a step of utilizing at least one roller applied to said framework to secure at least part of said overlapped framework.
101. The method as described in clause 100 or any other clause wherein said step of utilizing said at least one roller comprises steps of:
utilizing an upper roller and a lower roller,
contacting an upper surface of said overlapped framework with said upper roller; and
contacting said lower surface with said lower roller.
102. The method as described in clause 58 or any other clause wherein said step of securing at least part of said overlapped framework comprises a step of providing a grip surface on part of said framework.
103. The method as described in clause 102 or any other clause wherein said grip surface is selected from a corrugated surface, a rough surface, a lacerated surface, a scored surface, hatched surface, double hatched surface, and irregular hatching surface.
104. The method as described in clause 102 or any other clause and further comprising a step of locating said grip surface is located on one surface in between said overlapped framework or on both surfaces in between said overlapped framework.
105. The method as described in clause 63 or any other clause and further comprising a step of providing a grip surface on said inner layer surface selected from an inside layer top surface, an inside layer bottom surface, or both said inside layer top and bottom surfaces.
106. The method as described in clause 102 or any other clause wherein said step of providing a grip surface on part of said framework comprises a step of providing protrusions and depressions.
107. The method as described in clause 106 or any other clause and further comprising steps of:
providing a grip surface on both surfaces of an overlapped framework; overlapping said grip surfaces; and
mating said grip surfaces with each other.
108. The method as described in clause 107 or any other clause and further comprising providing a step of providing said grip surface on one of said surfaces that is different than a grip surface on an overlapping surface.
109. The method as described in clause 102 or any other clause and further comprising a step of applying high force to said overlapped framework.
110. The method as described in clause 109 or any other clause and further comprising a step of deforming said overlapped framework with said grip surface.

As can be easily understood from the foregoing, the basic concepts of the various embodiments of the present application(s) may be embodied in a variety of ways. It involves frame, frame precursor structure, frame section, framed panel structure and/or mounting technology techniques as well as devices to accomplish the appropriate frame, frame precursor structure, frame section, framed panel structure, and/or mounting technology. In this application, the frame, frame precursor structure, frame section, framed panel structure and/or mounting technology techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the various embodiments of the present application(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition, correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the application is described in device-oriented terminology, each element of the device implicitly performs a function. Apparatus claims may not only be included for the device described, but also method or process claims may be included to address the functions of the embodiments and that each element performs. Neither the description nor the terminology is intended to limit the scope of the claims that will be included in any subsequent patent application. As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. Terms like “overlaying”, “over” or the like may be direct contact, indirect contact, above, upon, cover, or the like.

It should also be understood that a variety of changes may be made without departing from the essence of the various embodiments of the present application(s). Such changes are also implicitly included in the description. They still fall within the scope of the various embodiments of the present application(s). A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the present application(s) both independently and as an overall system.

Further, each of the various elements of embodiments of the present application(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the present application(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the present application(s) are entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “fold” should be understood to encompass disclosure of the act of “folding”— whether explicitly discussed or not—and, conversely, were there effectively disclosure of the act of “folding”, such a disclosure should be understood to encompass disclosure of a “fold” and even a “means for folding.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components that are configured to, or configured and arranged to, achieve a particular result, use, purpose, situation, function, or operation, or as components that are capable of achieving a particular result, use, purpose, situation, function, or operation. All should be understood as within the scope of this disclosure and written description.

Any patents, publications, or other references mentioned in this present application for patent are hereby incorporated by reference. Any priority case(s) claimed by this present application is hereby appended and hereby incorporated by reference. In addition, as to each term used it should be understood that unless its utilization in this present application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in below list or other information statement filed with the application are hereby appended and hereby incorporated by reference, however, as to each of the above, to the extent that such information or statements incorporated by reference might be considered inconsistent with the patenting of the various embodiments of present application(s) such statements are expressly not to be considered as made by the applicant(s).

Thus, the applicant(s) should be understood to have support and make claims to embodiments including at least: i) each of the frame, frame precursor structure, frame section, framed panel structure, and/or mounting technologies as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent applications, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all applications described herein.

In addition and as to computer aspects and each aspect amenable to programming or other electronic automation, it should be understood that in characterizing these and all other aspects of the various embodiments of the present application(s)—whether characterized as a device, a capability, an element, or otherwise, because all of these can be implemented via software, hardware, or even firmware structures as set up for a general purpose computer, a programmed chip or chipset, an ASIC, application specific controller, subroutine, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of application to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent applications, and xxxiii) the various combinations of each of the above and of any aspect, all without limiting other aspects in addition. In addition, the applicant(s) should be understood to have support to claim and make a statement of application that may include claims directed to any of the enumerated embodiments and any permutation or combination thereof.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479F.3 d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this present application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of various embodiments of the present application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as desired to define the matter for which protection is sought by this present application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this present application including any subsequent continuation, division, or continuation-in-part application thereof or any reissue or extension thereon.

1. A frame for at least partially enclosing or supporting a solar panel comprising: an elongated piece of framework material having a first end and a second end, said first and second end defining lengthwise dimension; wherein said elongated piece of framework material is folded along said lengthwise dimension to form a folded framework having a panel containment structure configured to support part of a solar panel; wherein said folded framework comprises an overlap of at least part of said elongated piece of framework creating an overlapped framework; and a securement configured to secure said overlapped framework.

2. (canceled)

3. The frame as described in claim 1 wherein said panel containment structure comprises a lower shelf, a pocket wall, a top lip, and a pocket region.

4. The frame as described in claim 3 wherein said pocket region comprises said overlapped framework and wherein said securement is located between overlapped framework in said pocket region.

5. The frame as described in claim 1 wherein said overlap of said at least part of said elongated piece of framework comprises an overlap of said first end with said second end of said elongated piece of framework material.

6. The frame as described in claim 5 wherein said overlap of said first end with said second end of said at least part of said elongated piece of framework comprises a bend in said first end folded around a side edge of said second end.

7. The frame as described in claim 6 and further comprising an upper layer of said first end of said framework, an inner layer of said second end of said framework, and a bottom layer of said wrapped first end of said framework.

8. (canceled)

9. The frame as described in claim 1 wherein said securement comprises teeth at one of said first or second ends configured to frictionally engage with said overlapped framework.

10. (canceled)

11. The frame as described in claim 10 wherein said bent teeth are bent at an angle selected from between about 0 degrees and about 90 degrees; about 5 degrees; about 10 degrees;
about 15 degrees; and less than about 90 degrees.

12. (canceled)

13. (canceled)

14. (canceled)

15. (canceled)

16. (canceled)

17. The frame as described in claim 1 wherein said securement comprises a dimple feature in said overlapped framework.

18. The frame as described in claim 17 wherein said dimple feature comprises a dimple formed in an inner layer of said overlapped framework, wherein said dimple is configured to lock said inner layer with an overlapped layer of framework.

19. The frame as described in claim 17 wherein said dimple feature comprises a nesting dimple in each layer of said overlapped framework.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The frame as described in claim 1 wherein said securement comprises a tab lock.

32. The frame as described in claim 31 wherein said tab lock comprises a hole in one of said overlapping layers and a tab in the other of said overlapping layers wherein said tab configured to lock into said hole.

33. The frame as described in claim 32 wherein said tab lock comprises at least two tabs for each hole.

34. The frame as described in claim 32 wherein said tabs comprise a bent tab at an angle selected from about 90 degrees, less than about 90 degrees, and more than about 90 degrees.

35. (canceled)

36. (canceled)

37. The frame as described in claim 31 wherein said overlapped framework comprises a plurality of tab locks.

38. (canceled)

39. (canceled)

40. (canceled)

41. The frame as described in claim 1 wherein said securement comprises an adhesive between said overlapped framework.

42. (canceled)

43. (canceled)

44. (canceled)

45. (canceled)

46. (canceled)

47. (canceled)

48. The frame as described in claim 1 wherein said securement comprises a grip surface on part of said framework.

49. The frame as described in claim 48 wherein said grip surface is selected from a corrugated surface, a rough surface, a lacerated surface, a scored surface, hatched surface, double hatched surface, and irregular hatching surface.

50. (canceled)

51. (canceled)

52. (canceled)

53. The frame as described in claim 48 wherein said grip surface comprises protrusions and depressions.

54. The frame as described in claim 48 wherein both surfaces of an overlapped framework comprise said grip surface and when overlapped said grip surfaces mate with each other.

55. The frame as described in claim 51 wherein said grip surface on one of said surfaces is different than a grip surface on the overlapping surface.

56. (canceled)

57. (canceled)
